(19) United States
(12) Patent Application Publication
(10) Pub. No.: US 2002/0188569 A1
(43) Pub. Date: Dec. 12, 2002

(54) Method of and apparatus for intermediating transportation, and computer product

(75) Inventors: Yasuhiro Nishimura, Kawasaki (JP); Hajime Suetsugu, Kawasaki (JP); Takashi Sugihara, Hiroshima (JP); Toshiyasu Kojima, Hiroshima (JP)

Correspondence Address: STAAS & HALSEY LLP, 700 11TH STREET, NW, SUITE 500, WASHINGTON, DC, 20001, US

(73) Assignee: Fujitsu Limited of Kawasaki, Japan

(21) Appl. No.: 09/956,809

(22) Filed: Sep. 21, 2001

(30) Foreign Application Priority Data
Apr. 25, 2001 (JP) 2001-128469

(51) Int. Cl. G06F 17/60

(52) U.S. Cl. 705/55

(57) ABSTRACT

A transportation intermediation apparatus includes a main control section. The main control section causes a consignor to input a transportation condition of a package with a consignor client, shows transportation fees of respective forwarding agents matching with the transportation condition to the consignor, causes the consignor to select a forwarding agent as a transportation assignee from a plurality of forwarding agents, and orders a forwarding agent client of the selected forwarding agent to perform a transportation business through the internet.

### FIELD OF THE INVENTION

The present invention relates to a technology for performing transportation intermediation between a client (consignor and consignee) who receives transportation service and a plurality of forwarding agents. More particularly, this invention relates to a technology which can improve the facilities for clients and transportation efficiency on a forwarding agent side and which can achieve a reduction in cost of transportation service.

### BACKGROUND OF THE INVENTION

In recent years, with the development of a distribution system which bears transportation of packages, service in which a time zone of delivery can be designated and package collection service are performed, and the facilities for clients are considerably improved. On the other hand, competition for catching clients between forwarding agents becomes strong. The forwarding agents compete with each other for decreases in transportation fee and the thickness of service contents.

However, in a conventional technique, transportation fee systems and service contents vary depending on forwarding agents. For this reason, when an optimum forwarding agent best for a client is selected from a plurality of forwarding agents, long time and labor are required. Therefore, unit and methods for effectively solving the problem are strongly desired.

As described above, in a conventional distribution system, transportation fee systems and service contents vary depending on forwarding agents. Therefore, a forwarding agent spends advertising expenses to announce a transportation fee system or service contents through various electronic media and paper media, and develops a strategy for discrimination from another agent in the same business.

On the other hand, a consignor who consigns a package for transportation to a forwarding agent inquires transportation fee systems and service contents from respective forwarding agents depending on the degree of emergency or the characteristics of the package, and consigns the package for transportation to a forwarding agent which seems to be optimum.

In the transportation assignment, a consignor must write the name, address, and telephone number of a consignee which is the destination of the package, the name, address, telephone number of the consignor, desired date and time for delivery, package information, and the like in a slip (original/invoice). The package on which the slip is adhered is collected by a person in charge of transportation of a forwarding agent and delivered from a branch which covers the address of the consignor to the consignee through another branch which covers the address of the consignee.

As described above, the conventional art describes that a consignor inquires a transportation fee system and service contents from each forwarding agent and selects a forwarding agent which is seemed to be optimum from a plurality of forwarding agents.

It takes a long time and labor that a consignor individually inquires of a plurality of forwarding agents. Therefore, in fact, it is general that a transportation business is continuously consigned to a specific forwarding agent.

For this reason, conventionally, even though another forwarding agent has a small transportation fee and thick service contents, a consignor loses because the consignor does not know the forwarding agent has a small transportation fee and full service contents may frequently occur. More specifically, in the conventional art, pieces of information related to respective forwarding agents are spread. Since there is no unit used when a consignor effectively obtain valid information, the consignor slightly obtains facilities.

Conventionally, each time transportation is consigned to a forwarding agent, a consignor must write consignor information, consignee information, package information, and the like in a slip. As the number of times of assignment increases, information is cumbersomely written in a slip.

Conventionally, since a forwarding agent has no unit for notifying a consignee of a time and date of delivery of a package in advance, the frequency of redelivery because of the absence of the consignee is higher than that when the consignee knows the time and date of delivery. For this reason, transportation efficiency is not improved, and personnel expenses are high disadvantageously.

### SUMMARY OF THE INVENTION

It is an object of this invention to provide a method of and an apparatus for transportation intermediation which can improve the facilities for a client which receives transportation service and transportation efficiency of a forwarding agent and which can achieve a reduction in cost of transportation service. It is another object of this invention to provide a computer program which when executed on a computer realizes the method according to the present invention.

According to the present invention, a consignor inputs transportation condition/s of a package, and a transportation information database is searched based on the input transportation condition as key/s. This transportation information database storing information regarding transportation fees corresponding to a plurality of forwarding agents. The information about transportation fee/s hit in the searching and forwarding agent/s corresponding to hit transportation fee/s is provided to the consignor. The consignor selects a forwarding agent as a transportation assignee based on the provided information. Finally, an order is given to the forwarding agent selected by the consignor to perform transportation of the package.

Thus, transportation fees of the candidate forwarding agents are shown to a consignor by using the transportation condition/s input by the consignor as key/s. Moreover, the forwarding agent selected by the consignor is given an order to perform a transportation business. For this reason, in comparison with a conventional case in which a consignor inquires of respective forwarding agents, the facilities for the consignor which receives transportation service can be improved, and a reduction in cost because transportation fees are compared with each other can be achieved.

Other objects and features of this invention will become apparent from the following description with reference to the accompanying drawings.

### BRIEF DESCRIPTION OF THE DRAWINGS

FIG. 1 is a block diagram showing the configuration of an embodiment according to the present invention;

FIG. 2 is a diagram showing the configurations of transportation information files 310₁ and 310₂ shown in FIG. 1;

FIG. 3 is a diagram showing an example of a forwarding agent information database 600 shown in FIG. 1;

FIG. 4 is a diagram showing an example of a branch information database 610 shown in FIG. 1;

FIG. 5 is a diagram showing an example of a transportation fee information database 620 shown in FIG. 1;

FIG. 6 is a diagram showing an example of a transportation area information database 630 shown in FIG. 1;

FIG. 7 is a diagram showing an example of a client information database 640 shown in FIG. 1;

FIG. 8 is a diagram showing an example of a transportation request information database 650 shown in FIG. 1;

FIG. 9 is a diagram showing an example of a transportation assignment information database 660 shown in FIG. 1;

FIG. 10 is a diagram showing an example of a transportation achievement information database 670 shown in FIG. 1;

FIG. 11 is a diagram showing an example of a transportation achievement information master 671 shown in FIG. 10;

FIG. 12 is a diagram showing an example of a transportation achievement information table 672₁ for forwarding agent A shown in FIG. 10;

FIG. 13 is a diagram for explaining an operation outline of the embodiment;

FIG. 14 is a flow chart for explaining an operation of the embodiment;

FIG. 15 is a flow chart for explaining an anonymous application process shown in FIG. 14;

FIG. 16 is a flowchart for explaining a transportation fee discount process shown in FIG. 15;

FIG. 17 is a diagram showing an example of an anonymous application screen 800 in the embodiment;

FIG. 18 is a diagram showing an example of a transportation assignee selection screen 810 in the embodiment;

FIG. 19 is a diagram showing an example of a detailed information input screen 820 in the embodiment;

FIG. 20 is a diagram showing an example of a assignment contents confirmation screen 830 in the embodiment;

FIG. 21 is a diagram showing an example of a final confirmation screen 840 in the embodiment;

FIG. 22 is a diagram showing an example of an order confirmation mail 850 in the embodiment;

FIG. 23 is a diagram showing an example of a reception request mail 860 in the embodiment;

FIG. 24 is a diagram showing an example of an in-progress mail 860 in the embodiment;

FIG. 25 is a diagram showing an example of a transportation completion mail 890 in the embodiment;

FIG. 26 is a diagram for explaining an initial registration process shown in FIG. 14;

FIG. 27 is a diagram for explaining a transportation fee discount process in the embodiment;

FIG. 28 is a diagram for explaining a process of forming a transportation achievement information table for a forwarding agent in the embodiment; and

FIG. 29 is a block diagram showing the configuration of a modification of the embodiment.

### DESCRIPTION OF THE PREFERRED EMBODIMENTS

An embodiment of a transportation intermediation method according to the present invention will be described below with reference to the accompanying drawings.

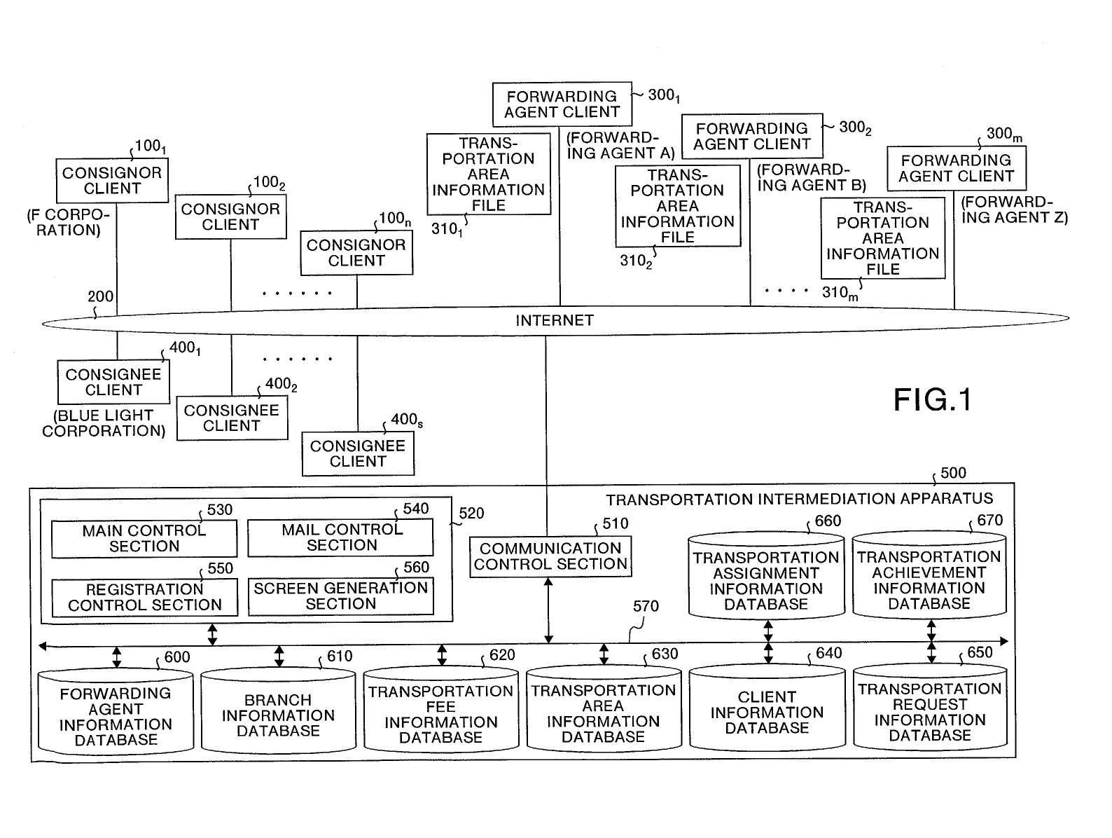

FIG. 1 is a block diagram showing the configuration of an embodiment according to the present invention. FIG. 1 shows a transportation intermediation system in which consignor clients 100₁ to 100ₙ, forwarding agent clients 300₁ to 300ₘ, consignee clients 400₁ to 400ₛ, and a transportation intermediation apparatus 500 are connected to the internet 200. In FIG. 1, for the sake of descriptive convenience, communication devices (terminal adapters, routers, fire walls, and the like) required for internet connection are not omitted.

The consignor clients 100₁ to 100ₙ are n computers installed on consignor sides on which forwarding agents are requested to send packages. The consignor clients 100₁ to 100ₙ access the transportation intermediation apparatus 500 (to be described later) through the internet 200 according to the TCP/IP (Transmission Control Protocol/Internet Protocol). Each of the consignor clients 100₁ to 100ₙ is constituted by a computer body, a display, a keyboard, a mouse, and the like. In FIG. 1, the consignor client 100₁ is installed in F corporation serving as a consignor.

The consignor clients 100₁ to 100ₙ are used to select forwarding agents and input detailed information such as addresses, names, and the like of consignors. In addition, the consignor clients 100₁ to 100ₙ comprises mailers (not shown) and browsers, respectively. The mailer provides a function for transmitting/receiving electronic mails through a mail server (not shown).

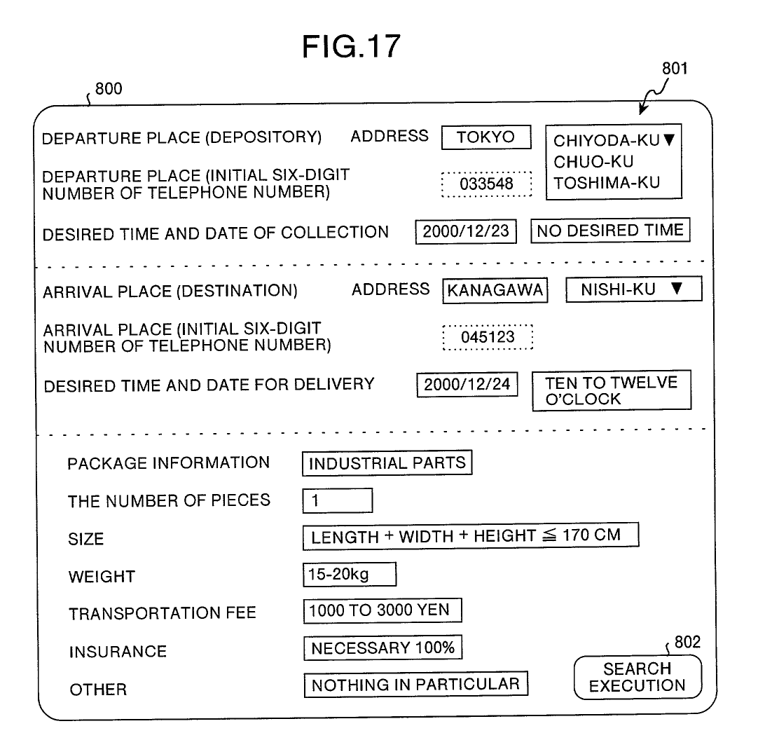

In transmission/reception of electronic mails, SMTP (Simple Mail Transfer Protocol) and POP3 (Post Office Protocol version 3) are used. The browsers are computer programs for browsing various screens (see FIGS. 17 to 21) provided by the transportation intermediation apparatus 500.

The forwarding agent clients 300₁ to 300ₘ are m computers installed at the forwarding agents A to Z, respectively. The forwarding agent clients 300₁ to 300ₘ access the transportation intermediation apparatus 500 through the internet 200 according to the TCP/IP. Each of the forwarding agent clients 300₁ to 300ₘ is constituted by a computer body, a display, a keyboard, a mouse, and the like. The forwarding agent clients 300₁ to 300ₘ are used for registration of transportation information to the transportation intermediation apparatus 500, reception of a transportation request notice, and the like.

The forwarding agent clients 300₁ to 300ₘ are connected to transportation management systems which are uniquely structured for each forwarding agents A to Z. The transportation management system is a system for performing assignment of transportation, vehicle arrangement, management, and the like on the basis of a transportation information database, a transportation area information database, a client information database, and the like. The forwarding agent clients 300₁ to 300ₘ comprise transportation area information files 310₁ to 310ₘ used in the transportation management system, respectively.

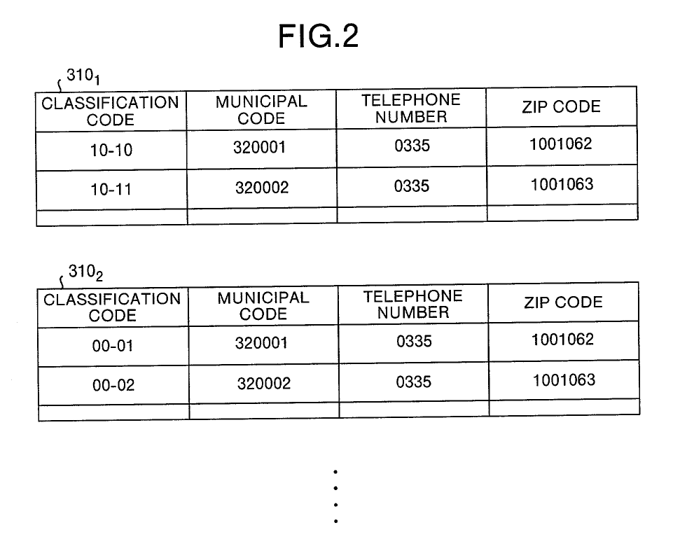

FIG. 2 is a diagram showing the configurations of the transformation area information files 310₁ to 310₂. The transportation area information files 310₁ and 310₂ are constituted by transportation area information for discriminating package collection areas and package delivery areas from each other. More specifically, the transportation area information is information for discriminating areas including the addresses of consignors and consignees.

More specifically, the transportation area information file 310₁ is used in forwarding agent A, and comprises fields or the like of “classification code”, “municipal code”, “telephone number”, and “zip code”. In this embodiment, in transportation area information file 310₁, for example, actual address information such as “1-chome Otemachi Chiyoda-ku, Tokyo” may be stored. The “classification code” is information, set by a rule unique to forwarding agent A, for discriminating transportation areas from each other. Therefore, the “classification code” cannot be used in forwarding agents other than forwarding agent A.

The “municipal code” is a code for discriminating administrative areas of the whole country in units of municipalities, and is a code which can be commonly used for the forwarding agents A to Z. The “telephone number” is information for discriminating the areas of the whole country by an initial digit number (several-digit number) of a telephone number. The “zip code” is information for discriminating the areas of the whole country by zip codes.

In forwarding agent A, a transportation business is performed by using the “classification code” of the “classification code” to the “zip code” described above. In the other forwarding agents B to Z, as in forwarding agent A, “classification codes” unique to the respective forwarding agents are used in a transportation business.

The transportation area information file 3102 is used in forwarding agent B, as in forwarding agent A, and comprises fields or the like of “classification code”, “municipal code”, “telephone number”, and “zip code”. In this embodiment, as in the transportation area information file 310₁, actual address information may also be stored in the transportation area information file 310₂.

Returning to FIG. 1, the consignee clients 400₁ to 400ₛ are s computers installed on a plurality of consignee sides on which packages from the consignor are received. The consignee clients 400₁ to 400ₛ access the transportation intermediation apparatus 500 (to be described later) through the internet 200.

Each of the consignee clients 400₁ to 400ₛ is constituted by a computer body, a display, a keyboard, a mouse, and the like. In FIG. 1, the consignee client 400₁ is installed in Blue Light corporation serving as a consignee The consignee clients 400₁ to 400ₛ are used for reception or the like of a package reception request notice.

The transportation intermediation apparatus 500 is an apparatus for intermediating business related to transportation between a consignor, a forwarding agent, and a consignee through the internet 200. In the transportation intermediation apparatus 500, a communication control section 510 controls communication between the consignor clients 100₁ to 100ₙ, the forwarding agent clients 300₁ to 300ₘ, and the consignee clients 400₁ to 400ₛ through the internet 200 according to the TCP/IP. A control section 520 performs various control operations for realizing a transportation intermediation function.

More specifically, the control section 520 is constituted by a main control section 530, a mail control section 540, a registration control section 550, and a screen generation section 560. The main control section 530 executes control related transportation intermediation. The detailed operation of the main control section 530 will be described later. The mail control section 540 controls transmission/reception of electronic mails. The registration control section 550 executes control related to information registration into various databases (to be described later). The screen generation section 560 generates various screens (to be described later) (see transportation FIGS. 17 to 21). A bus 570 connects the respective sections of the transportation intermediation apparatus 500.

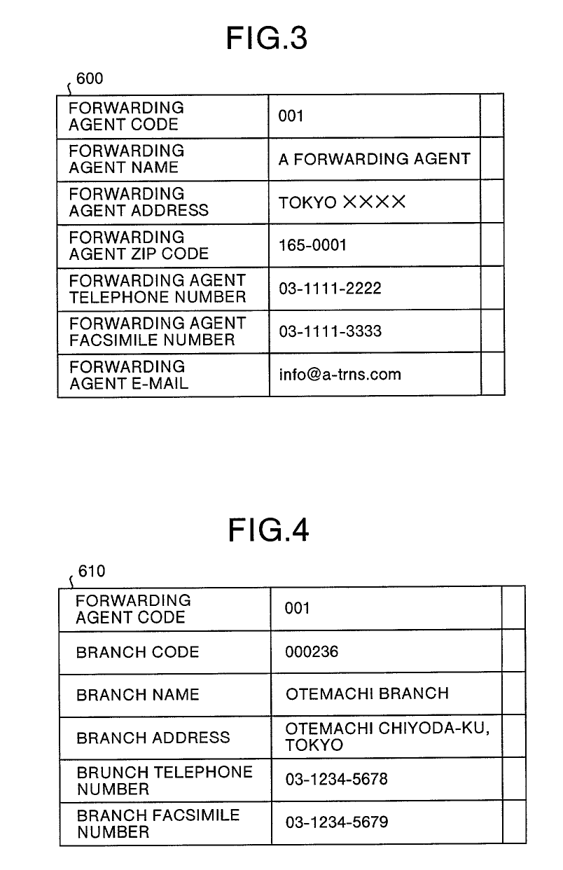

The forwarding agent information database 600 is a database in which forwarding agent information related to the forwarding agents A to Z registered in the transportation intermediation apparatus 500. More specifically, the forwarding agent information database 600, as shown in FIG. 3, comprises fields of “forwarding agent code”, “forwarding agent name”, “forwarding agent address”, “forwarding agent zip code”, “forwarding agent telephone number”, “forwarding agent facsimile number”, and forwarding agent E-mail”.

The “forwarding agent code” is a code for discriminating forwarding agents from each other. The “forwarding agent name” is information related to the names of forwarding agents. The “forwarding agent address” is information related to the addresses of the forwarding agents (head office). The “forwarding agent zip code” is information related to the zip codes of the forwarding agents. The “forwarding agent telephone number” is information related to the telephone numbers of the forwarding agents. The “forwarding agent facsimile number” is information related to the facsimile numbers of the forwarding agents. The “forwarding agent E-mail” is information related to the electronic mails of the forwarding agents.

Returning to FIG. 1, the branch information database 610 is a database for storing pieces of branch information related to branches of the forwarding agents A to Z. These branches spread over the whole country, and perform collection and delivery in transportation areas. More specifically, in a forwarding agent, a package is collected by a branch (departure branch) which covers a transportation area to which the consignor belongs. The package is transported to a branch (arrival branch) which covers a transportation area to which a consignee belongs through a network of the forwarding agent. The package is delivered to the consignee by a person in charge of transportation in the arrival branch.

The branch information database 610 comprises fields or the like of “forwarding agent code”, “branch code”, “branchname”, “branch address”, “branch telephone number”, and “branch facsimile number”. The “forwarding agent code” is a code for discriminating forwarding agents from each other, and corresponds to forwarding agent code” of the forwarding agent information database 600. The “branch code” is a code for discriminating branches of the forwarding agent corresponding to the “forwarding agent code”.

The “branch name” is information related to the names of branches. The “branch address” is information related to the address of branches. The “branch telephone number” is information related to the telephone numbers of branches. The “branch facsimile number” is information related to the facsimile numbers of branches.

Returning to FIG. 1, the transportation fee information database 620 is a database for storing pieces of transportation fee information related to rate systems of the forwarding agents A to Z are stored. More specifically, the transportation fee information database 620, as shown in FIG. 5, comprises fields or the like of “forwarding agent code”, “consignor classification code”, “consignor municipal code”, “consignee classification code”, “consignee municipal code”, “weight”, “size”, and “transportation fee”.

The “forwarding agent code” is a code for discriminating forwarding agents, and corresponds to the “forwarding agent code” of the forwarding agent information database 600. The “consignor classification code” is a classification code (see FIG. 2) used in the forwarding agent, and is a code for discriminating transportation areas corresponding to the addresses of consignors from each other. The “consignor municipal code” is a municipal code (see FIG., 2), and is a code for discriminating transportation areas corresponding to the addresses of consignors.

The “consignor classification code” is a classification code (see FIG. 2) used in the forwarding agent, and is a code for discriminating transportation areas corresponding to the addresses of consignees. The “consignee municipal code” is a municipal code (see FIG. 2), and is a code for discriminating transportation areas corresponding to the addresses of consignees. The “weight” is information related to the weights of packages serving as objects the transportation fees of which are calculated.

The “size” is information related to the sizes (length+width+height) of packages the transportation fees of which are calculated. The “transportation fee” is information related to transportation fees of the packages calculated by transportation distances specified by the “consignor classification code” and the “consignee classification code”, the “weight”, and the “size”. The “transportation fee information” is set for each of combinations of the “consignor classification code” (or “consignor municipal code”), a consignee classification code” (or “consignee municipal code”), the “weight”, and the “size”. Since the “transportation fee information” is set for each municipal, the “transportation fee information” varies depending on the forwarding agents.

In the embodiment, when a forwarding agent provides a plurality of transportation services using a plurality of trucks or motorcycles (motorcycle delivery) having different carrying capacities, the transportation fee information database 620 may have transportation service codes for discriminating transportation services from each other to set different transportation fees for the respective transportation services.

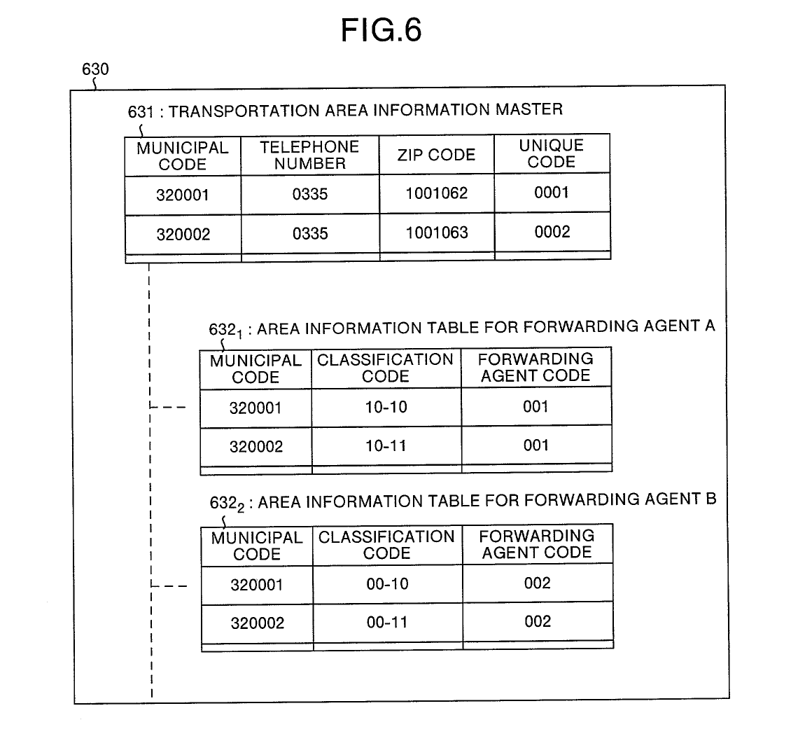

Returning to FIG. 1, the transportation area information database 630 is a database in which transportation area information used in the transportation intermediation apparatus 500 and pieces of transportation area information respectively used by the forwarding agents A to Z are stored. More specifically, as shown in FIG. 6, the transportation area information database 630 is constituted by a transportation area information master 631, an area information table 632₁ for forwarding agent A, an area information table 632₂ for forwarding agent B, . . . .

The transportation area information master 631 is a master for storing transportation area information used in the transportation intermediation apparatus 500, and comprises fields or the like of “municipal code”, “telephone number”, “zip code”, and “unique code”.

The “municipal code” is information for discriminating respective areas of the whole country in units of municipalities on the basis of administration, and is a code which can be commonly used by the forwarding agents A to Z. The “telephone number” is information for discriminating the respective areas of the whole country by an initial digit number (several-digit number) of a telephone number. The “zip code” is information for discriminating the areas of the whole country by zip codes.

The “unique code” is a code, uniquely set by a company for providing transportation intermediation service, for discriminating transportation areas, and is used as a common code in the transportation intermediation apparatus 500. Therefore, from the viewpoint of commonness, the “unique code” has same properties as those of the “municipal code”.

In the following description, the “municipal code” is used as a common code. However, the “unique code” may be used in place of the “municipal code”. However, in the embodiment, the “municipal code” and the “unique code” which are common codes do not have one-to-one correspondence. For example, a transportation area (area) represented by one municipal code may be divided into sub-areas, and a plurality of unique codes may be set to the sub-areas, respectively.

The area information table 632₁ for forwarding agent A is a table for storing area information for forwarding agent A used in forwarding agent A, and comprises fields or the like of “municipal code”, “classification code”, and “forwarding agent code”. The “municipal code” is equivalent to the “municipal code” of the transportation area information master 631. The “classification code” is equivalent to the “classification code” of the transportation area information file 310₁ (see FIG. 2), and is a code used in only forwarding agent A. The “forwarding agent code” is a code for discriminating forwarding agent A from other forwarding agents.

The area information table 632₂ for forwarding agent B is a table for storing area information for forwarding agent B, and comprises fields or the like of “municipal code”, “classification code, and “forwarding agent code”.

The “municipal code” is equivalent to the “municipal code” of the transportation area information master 631. The “classification code” is equivalent to the “classification code” of the transportation area information file 310₂ (see FIG. 2), and is a code used in only forwarding agent B. The “forwarding agent code” is a code for discriminating forwarding agent B from other forwarding agents.

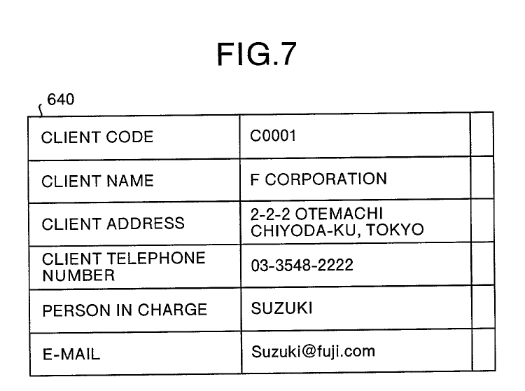

Returning to FIG. 1, the client information database 640 is a database for storing client information related to clients (consignors and consignees) who use transportation intermediation are stored. More specifically, the client information database 640, as shown in FIG. 7, comprises fields or the like of “client code”, “client name”, “client address”, “client telephone number”, “person in charge”, and “E-mail”.

The “client code” is a code for discriminating clients from each other. The “client name” is information related to the names (company names and person's names) of clients. The “client address” is information related to the address of clients. The “client telephone number” is information related to the telephone numbers of clients. The “person in charge” is information related to persons in charge when the clients are companies. The “E-mail” is information related to the electronic mail addresses of clients. In the embodiment, the client information database 640 may comprise not only the pieces of information described above but also point information or the like depending on frequencies of use for managing the using states of respective clients.

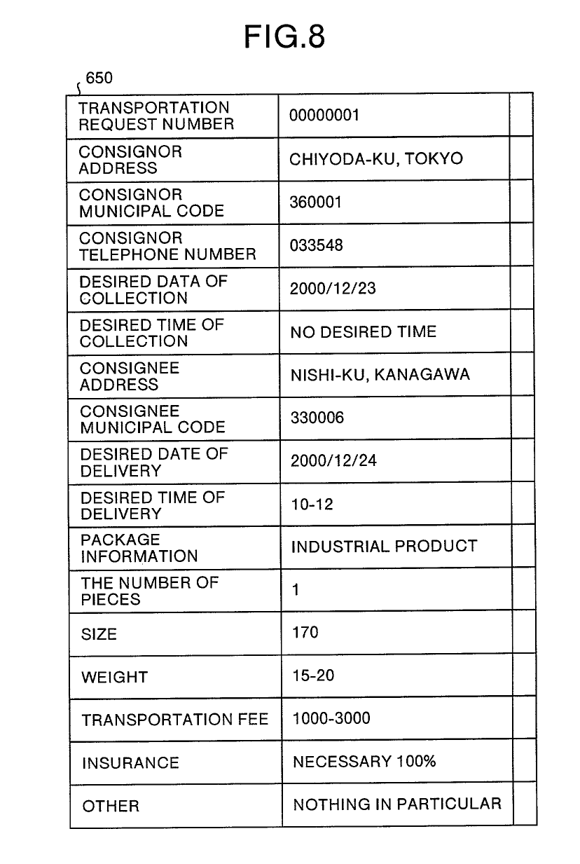

Returning to FIG. 1, the transportation request information database 650 is a database for storing transportation request information related to a transportation request of a package from a consignor. More specifically, the transportation request information database 650, as shown in FIG. 8, fields or the like of “transportation request number”, “consignor address”, a consignor municipal code”, “consignor telephone number”, “desired date of collection”, “desired time of collection”, “consignee address”, “consignee municipal code”, “desired date of delivery”, “desired time of delivery”, “package information, “the number of pieces”, “size”, “weight, “transportation fee”, “insurance”, and “other”.

The “transportation request number” represents numbers which are sequentially added to transportation requests to discriminate the transportation requests from each other. The “consignor address” is information related to the address of consignors. The “consignee municipal code” represents municipal codes corresponding to the addresses of consignees. The “consignor telephone number” is information related to telephone numbers of consignors. The “desired date of collection” is information relates to dates on which a forwarding agent collects packages from consignors. The “desired time of collection” is information related to time zones for collection.

The “consignee address” is information related to the addresses of consignees. The “consignee municipal code” represents municipal codes corresponding to the addresses of consignees. The “desired date of delivery” is information related to delivery dates of packages. The “desired time of delivery” is information related to delivery time zones of packages. The “package information” is information related to the types, contents, and the like of packages.

The “the number of pieces” is information related to the number of packages. The “size” is information related to the sizes (length+width+height) of the packages. The “weight” is information related to the weights of the packages. The “transportation fee” is information related to the range of transportation fees desired by consignors. The “insurance” is information related to insurances covering packages in transportation. The “other” is information related to specific items or the like.

Returning to FIG. 1, the transportation assignment information database 660 is a database for receiving a transportation requests from consignor and storing transportation assignment information related to assignment of the transformation business from the transportation intermediation apparatus 500 to a forwarding agent.

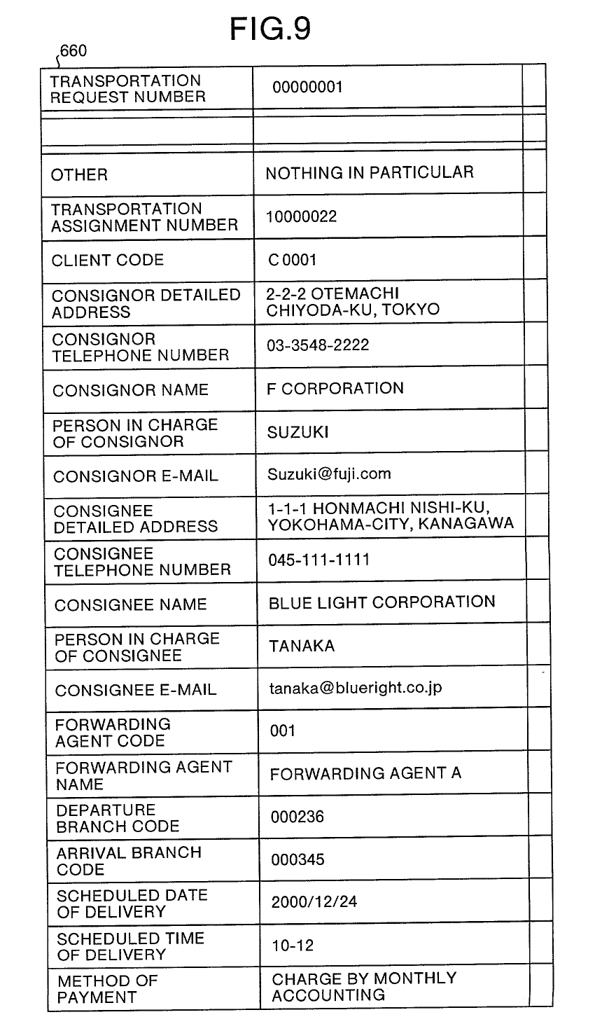

More specifically, the transportation assignment information database 660, shown in FIG. 9, comprises fields or the like of “transportation request number”, . . . , “other”, “transportation assignment number”, “client code”, consignor detailed address” “consignor telephone number”, “consignor name”, “person in charge of consignor”, “consignor E-mail”, “consignee detailed address”, “consignee telephone number”, “consignee name”, “person in charge of consignee, “consignee E-mail”, “forwarding agent code”, “forwarding agent name”, “departure branch code”, “arrival branch code”, “scheduled date of delivery”, “scheduled time for delivery”, and “paying method”.

The “transportation request number”, . . . , the “other” are equivalent to the “transportation request number”, the “other” of the transportation request information database 650 (see FIG. 8), respectively. The “transportation assignment number” represents numbers which are added each time transportation is consigned and are used to discriminate transportation assignments. The “client code” is information for discriminating clients (consignors), and corresponds to the “client code” of the client information database 640. The “consignor detailed address” is information related to the detailed addresses of consignors.

The “consignor telephone number” is information related to the telephone numbers of consignors. The “consignor name” is information related to the names of consignors (company names or person's names). The “person in charge of consignor” is information related to a person in charge of the transportation when a consignor is a company. The “consignor E-mail” is information related to the electronic mail addresses of consignors. The “consignee detailed address” is information related to the detail of address of consignees.

The “consignee telephone number” is information related to the telephone numbers of consignees. The consignee name” is information related to the names of consignees (company names or person's names). The “person in charge of consignee” is information related to a person in charge of the transportation when a consignee is a company. The “consignee E-mail” is information related to the electronic mail addresses of consignees. The “forwarding agent code” is a code for discriminating forwarding agents to which transportation is assigned, and corresponds to the “forwarding agent code” of the forwarding agent information database 600.

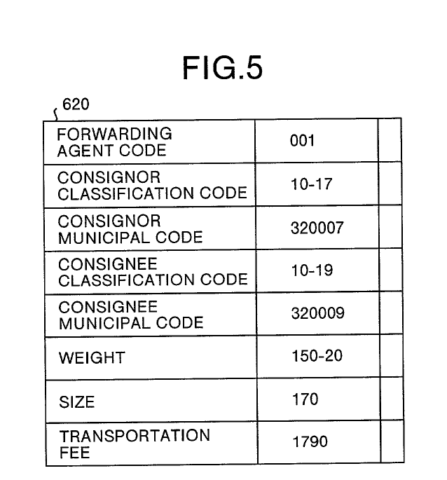

The “forwarding agent name” is information related to the names of forwarding agents to which transportation is assigned. The “departure branch code” is a branch code (see FIG. 4) for discriminating departure branches which collect packages from consignors from each other. The “arrival branch code” is a branch code (see FIG. 4) for discriminating arrival branches which deliver the packages to consignees from each other. The “scheduled date of delivery” is information related to scheduled dates on which the packages are delivered to the consignees. The “scheduled time for delivery” is information related to scheduled time zones in which the packages are delivered to the consignees. The “paying method” is information related to a paying method used when consignors pay transportation fees to forwarding agents.

The transportation assignment information database 660 comprises all pieces of information (including information which is not illustrated) related to packages which are being requested to be transported. In addition, in the embodiment, the transportation assignment information database 660 may comprises a client code for a consignee which is similar to a client code for a consignor.

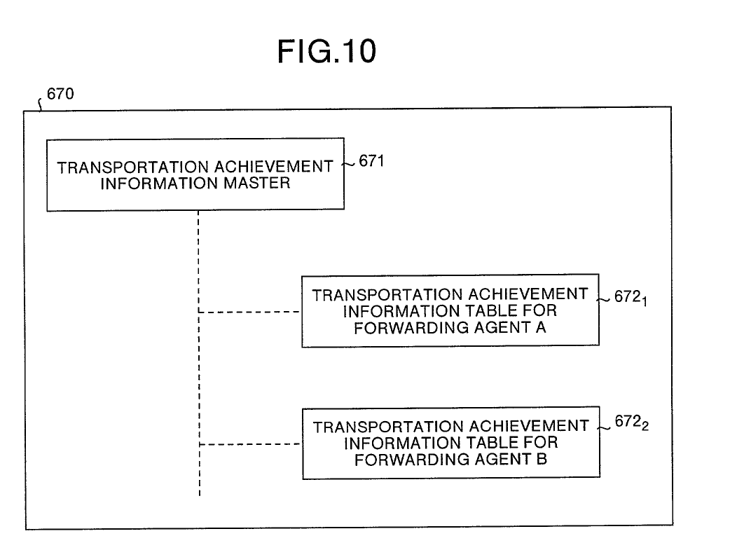

Returning to FIG. 1, the transportation achievement information database 670 is a database for storing transportation achievement information related to the achievement of consigned transportation used in the transportation intermediation apparatus 500 and transportation achievement information used in respective forwarding agents to which transportation is assingned. More specifically, the transportation achievement information database 670, as shown in FIG. 10, is constituted by the transportation achievement information master 671, a transportation achievement information table 672₁ for forwarding agent A, a transportation achievement information table 672₂ for forwarding agent B, . . . .

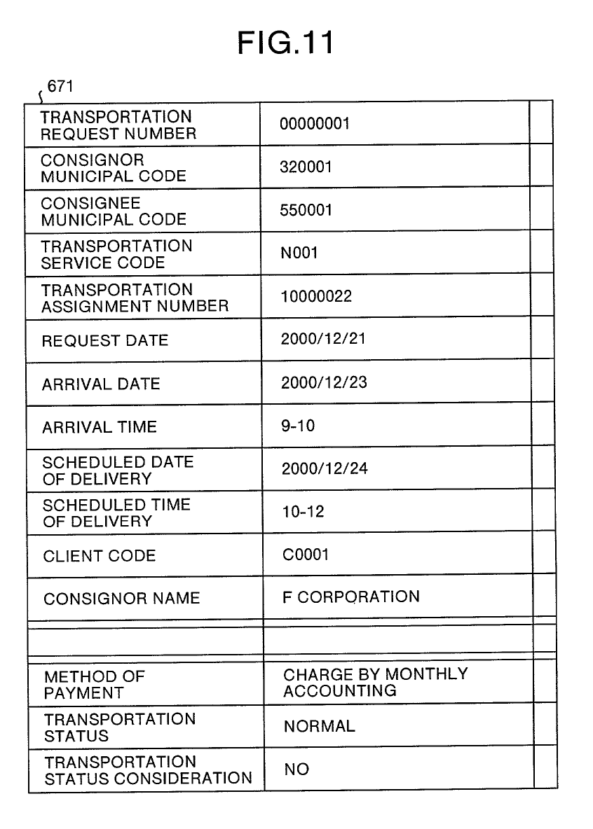

The transportation achievement information master 671 is a master for storing the transportation achievement information used in the transportation intermediation apparatus 500. The transportation achievement information master 671, as shown in FIG. 11, fields or the like of “transportation request number”, “consignor municipal code”, “consignee municipal code”, “transportation service code”, “transportation assignment number”, “request date”, “arrival date”, “arrival time”, “scheduled date of delivery”, “scheduled time for delivery”, “client code”, “consignor name”, . . . , “paying method”, “transportation status”, and “transportation status consideration”. In addition, the transportation achievement information master 671 also comprises a forwarding agent code or the like (not shown).

The “transportation request number”, the “consignor municipal code”, and “consignee municipal code” are equivalent to the “transportation request number”, the “consignor municipal code”, and “consignee municipal code” of the transportation request information database 650 (see FIG. 8), respectively. The “transportation service code is a code for discriminating transportation services from each other. The “transportation assignment number” is equivalent to the “transportation assignment number of the transportation assignment information database 660 (see FIG. 9).

The “request date” is information related to dates on which packages are requested by consignors to be transported. The “arrival date” is information related to dates on which the packages arrive at arrival branches. The “arrival time” is information related to a time zone in which the packages arrive at arrival branches. The “scheduled date of delivery” is information related to a scheduled time zone in which the packages are delivered to consignees. The “scheduled time for delivery” is information related to scheduled time zones in which the packages are delivered to the consignees. The “client code” is a code for discriminating clients from each other, and corresponds to the “client code” of the client information database 640. The “consignor name”, . . . , the “paying method” are equivalent to the “consignee name”, . . . , the “paying method” of the transportation assignment information database 660, respectively.

The “transportation status” is information representing the transportation statuses (normal statuses, abnormal statuses, transportation completion, and the like) of the packages. As an example of the abnormal status, a case in which delivery is behind a scheduled time because of a traffic condition or the like is known. The “transportation status consideration” is information related to detailed information (e.g., delivery is one hour behind scheduled time because of a traffic jam). Although not shown, the transportation achievement information master 671 also includes a transportation request or package information included in transportation assignment information, arrangement information related to a transportation vehicles arranged for delivery by a forwarding agent, and the like.

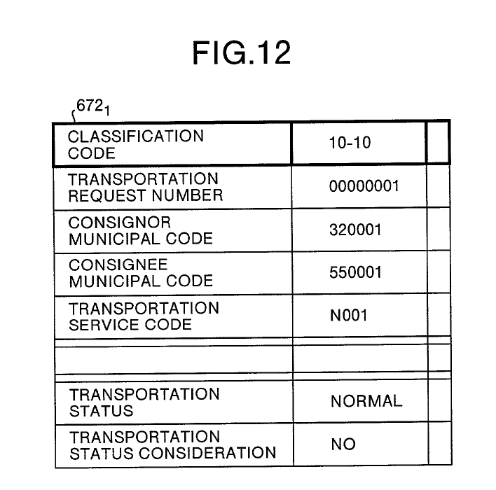

Returning to FIG. 10, the transportation achievement information table 672₁ is a table for storing transportation achievement information for forwarding agent A obtained by adding “classification code” used in forwarding agent A to the transportation achievement information of the transportation achievement information master 671. More specifically, as shown in FIG. 12, the transportation achievement information table 672₁ comprises fields or the like of “classification code”, “transportation request number”, “consignor municipal code”, “consignee municipal code”, “transportation service code”, . . . , “transportation status”, and “transportation status consideration”.

The “classification code” is equivalent to the “classification code” (transportation area information file 310₁: see FIG. 2) used in forwarding agent A. The “transportation request number” to the “transportation status consideration” are equivalent to the “transportation request number” to the “transportation status consideration” of the transportation achievement information master 671 (see FIG. 11).

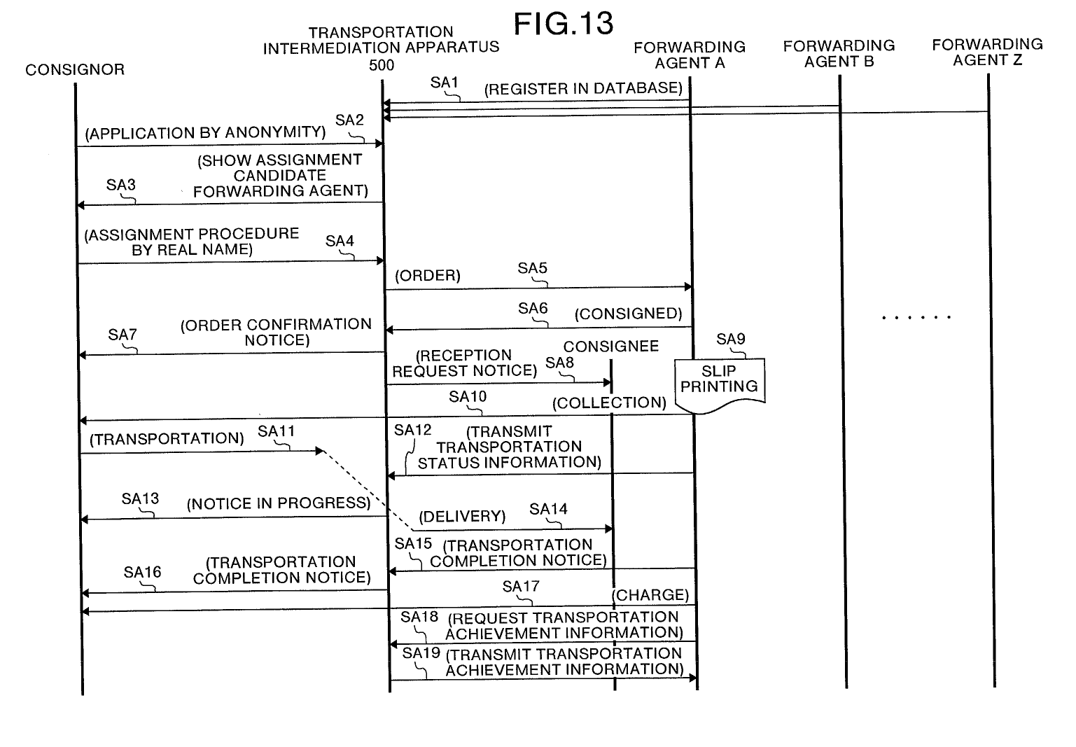

The operation of the embodiment will be described below. First, the outline of the operation of the embodiment will be described below with reference to the flow chart shown in FIG. 13. In the following description explains a case in which F corporation (consignor) (shown in FIG. 1) consigns a package to forwarding agent A through the transportation intermediation apparatus 500, and the package is delivered by forwarding agent A to Blue Light corporation (consignee)

In step SA1 shown in FIG. 13, forwarding agent information, branch information, transportation fee information, and the like provided by the forwarding agents A to Z are registered in the forwarding agent information database 600 (see FIG. 3), the branch information database 610 (see FIG. 4), the transportation fee information database 620 (see FIG. 5), and the like, respectively. In step SA2, a consignor (F corporation) anonymously requests the transportation intermediation apparatus 500 to transport a package.

In step SA3, the transportation intermediation apparatus 500 shows a plurality of forwarding agents as assignment candidates to the consignor on the basis of the transportation request contents and the transportation fee information database 620. In step SA4, after a forwarding agent (forwarding agent A in FIG. 13) to which transportation is assigned is selected from the plurality of shown forwarding agents is selected by the consignor, and a assignment procedure is performed by the consignor with the real name thereof.

In step SA5, the transportation intermediation apparatus 500 transmits slip information (consignor information, cosignee information, package information, desired time and date of collection, desired time and date of delivery, and the like) required to print a slip (to be described later), and orders forwarding agent A to perform a transportation business. In step SA6, the transportation business is assigned by forwarding agent A, and assignment information obtained by adding arrangement information or the like of transportation vehicles to the information accepted as the assignment information is notified to the transportation intermediation apparatus 500. In step SA7, the transportation intermediation apparatus 500 notifies the consignor of order confirmation. In step SA8, the transportation intermediation apparatus 500 notifies a consignee (Blue Light corporation) that the consignee is requested to receive the package.

In step SA9, a slip for transportation is printed on the basis of the slip information from the transportation intermediation apparatus 500. In the embodiment, the slip may be printed at a timing at which the transportation business is assigned to the forwarding agent in step SA6. In step SA10, the package of the consignor is collected by forwarding agent A. In step SA11, the collected package is transported by forwarding agent A. In step SA12, transportation status information representing a transportation status (normal status or abnormal status) is transmitted to the transportation intermediation apparatus 500 by forwarding agent A.

In this case, the forwarding agent does not spontaneously transmits the transportation status information. The transportation intermediation apparatus 500 may periodically inquire a transportation state from the forwarding agent, and may receive the transportation status from each forwarding agent as a replay to the inquiry.

In step SA13, when the transportation intermediation apparatus 500 recognizes that the transportation status is abnormal (e.g., delayed delivery), and the transportation intermediation apparatus 500 notifies the consignor that the transportation status is abnormal as a status in progress. In step SA14, the package is delivered by forwarding agent A to the consignee. In step SA15, forwarding agent A notifies the transportation intermediation apparatus 500 that the transportation of the package is completed.

In step SA16, the transportation intermediation apparatus 500 notifies the consignor that the transportation of the package is completed. In step SA17, forwarding agent A requests the consignor to pay the transportation fee. In step SA18, forwarding agent A requests the transportation achievement information from the transportation intermediation apparatus 500. In step SA19, the transportation intermediation apparatus 500 transmits the transportation achievement information to forwarding agent A.

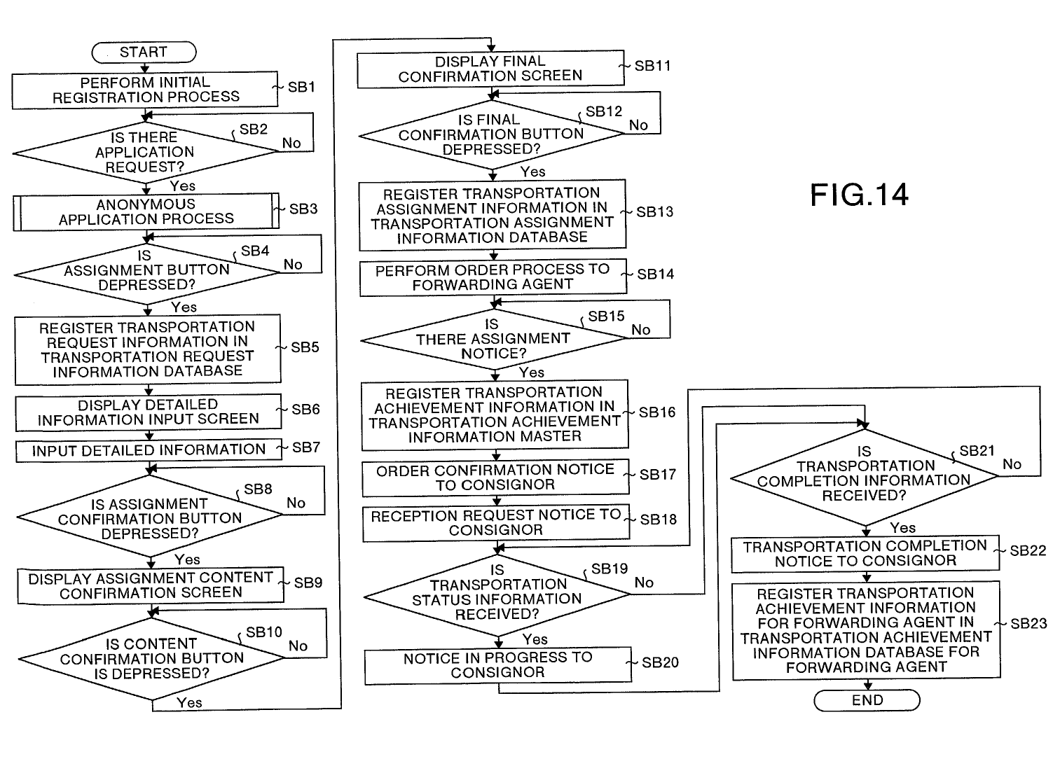

The detailed operation of the embodiment will be described below with reference to the flow charts shown in FIGS. 14 to 16 and FIGS. 17 to 28. In step SB1 shown in FIG. 14, an initial registration process for registering pieces of information in the forwarding agent information database 600 (see FIG. 3), the branch information database 610 (see FIG. 4), the transportation fee information database 620 (see FIG. 5), and the “transportation area information database 630 (see FIG. 6), respectively, is executed.

More specifically, when the registration control section 550 of the transportation intermediation apparatus 500 receives forwarding agent information files (not shown) corresponding to the forwarding agents A to Z from the forwarding agent clients 300₁ to 300ₘ through the internet 200, the registration control section 550 registers pieces of forwarding agent information included in these forwarding agent information files in the forwarding agent information database 600 (see FIG. 3).

When the registration control section 550 of the transportation intermediation apparatus 500 receives branch information files (not shown) corresponding to the forwarding agents A to Z from the forwarding agent clients 300₁ to 300ₘ through the internet 200, the registration control section 550 registers pieces of branch information included in the branch information files in the branch information database 610 (see FIG. 4).

When the registration control section 550 of the transportation intermediation apparatus 500 receives transportation fee information files (not shown) corresponding to the forwarding agents A to Z from the forwarding agent clients 300₁ to 300ₘ through the internet 200, the registration control section 550 registers pieces of transportation fee information included in the transportation fee information files in the transportation fee information database 620 (see FIG. 5).

When the registration control section 550 of the transportation intermediation apparatus 500 receives transportation area information files 310₁ to 310ₘ (see FIG. 2) corresponding to the forwarding agents A to Z from the forwarding agent clients 300₁ to 300ₘ through the internet 200, the registration control section 550 forms or updates the area information table 632₁ for the forwarding agent A, the area information table 632₂ for the forwarding agent B, . . . , shown in FIG. 6 on the basis of the transportation area information and the forwarding agent codes included in the transportation area information files 310₁ to 310ₘ and the transportation area information master 631 (see FIG. 6).

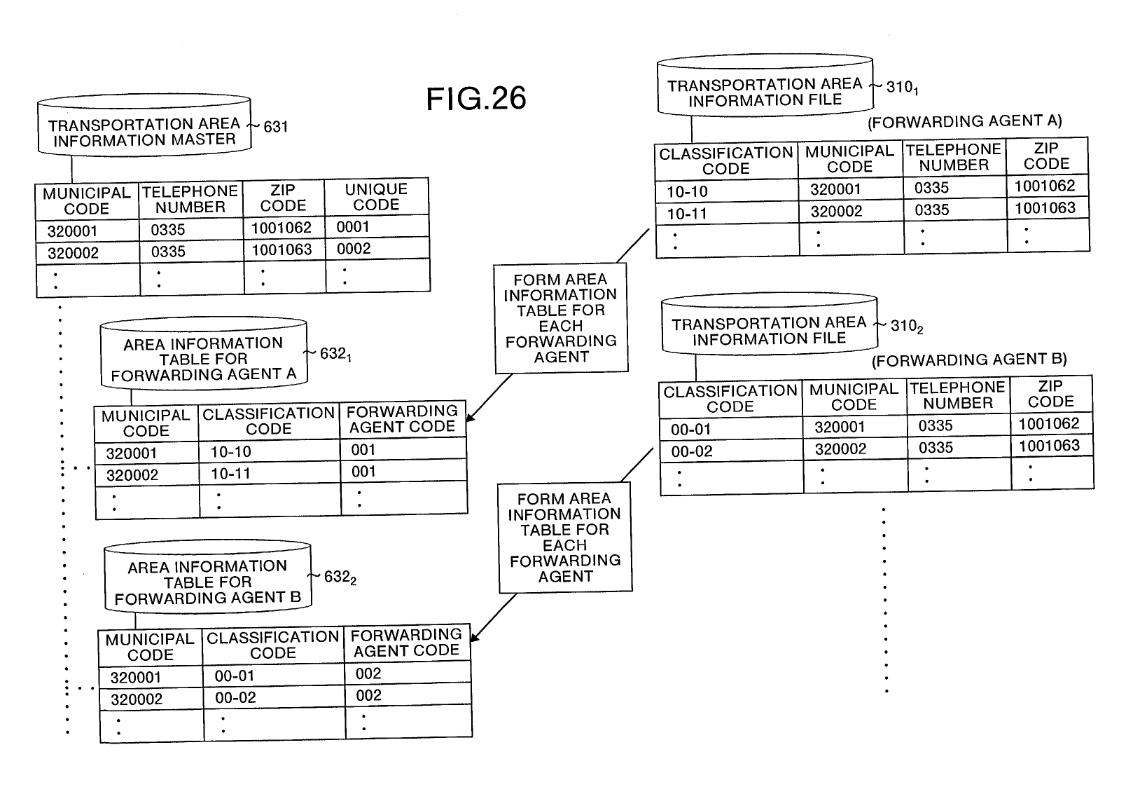

More specifically, when the registration control section 550 receives the transportation area information file 310₁ and the forwarding agent code corresponding to the forwarding agent A shown in FIG. 26 from the forwarding agent client 300₁ through the internet 200, the registration control section 550 searches for the transportation area information master 631 by using “municipal code” included in the transportation area information file 310₁ as a key.

The registration control section 550 forms or updates the area information table 632₁ for the forwarding agent A comprising the fields or the like of the “municipal code”, the “classification code”, and the “forwarding agent code” with respect to the transportation area information master obtained as a searching result, and registers the area information table 632₁ in the transportation area information database 630 (see FIG. 6).

Similarly, when the registration control section 550 receives the transportation area information file 310₂ shown in FIG. 26 and the forwarding agent code corresponding to the forwarding agent B from the forwarding agent client 300₂ (the forwarding agent B) through the internet 200, the registration control section 550 searches for the transportation area information master 631 by using the “municipal code” included in the transportation area information file 310₂ as a key. The embodiment describes the case in which the municipal code is used as a key. However, a unique code may be used as a key in place of the municipal code.

The registration control section 550 forms or updates the area information table 632₂ for the forwarding agent B comprising the fields or the like of the “municipal code”, the “classification code”, and the “forwarding agent code” with respect to the transportation area information master obtained as a searching result, and registers the area information table 632₂ in the transportation area information database 630 (see FIG. 6).

Returning to FIG. 14, in step SB2, the main control section 530 decides whether a transportation request is made by any consignor client (consignor) of the consignor clients 100₁ to 100ₙ or not. The main control section 530 decides the result as “NO” to repeat the decision until the transportation request is made.

For example, when the consignor client 100₁ (F corporation) applies to Blue Light corporation (consignee) for transportation of a package, the main control section 530 decides the decision result of step SB2 as “Yes”. In step SB3, the main control section 530 executes an anonymous application process in which an anonymous application from a consignor is accepted.

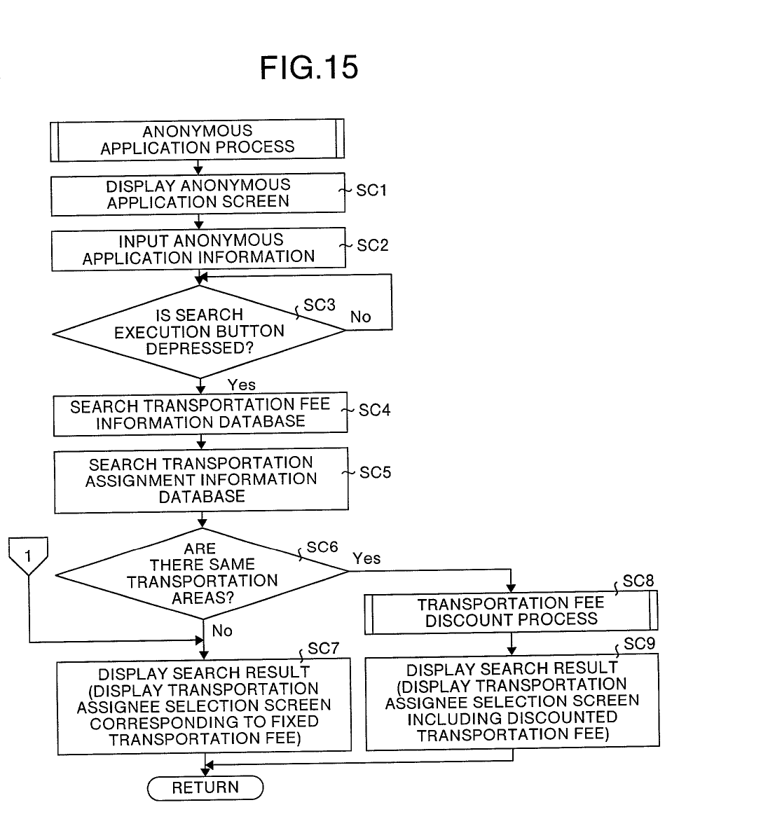

More specifically, in step SC1 shown in FIG. 15, when the main control section 530 displays an anonymous application screen 800 shown in FIG. 17 on a display section (not shown) of the consignor client 100₁. The anonymous application screen 800 is used when a consignor (in this case, F corporation) performs an anonymous application of transportation. In this anonymous application screen 800, a anonymous application information input column 801 for inputting departure place information, arrival place information, and package information, a search execution button 802, and the like are displayed.

The departure place information includes the address of a consignor, the initial six-digit number of the telephone number of a consignee, and desired time and date of collection of the package. The arrival place information includes the address (municipalities) of the consignor, the initial six-digit number of the telephone number of the consignee, and desired time and date of delivery of the package. The package information includes package information representing the type of the package, the number of pieces, sizes (length+width+height), weights, a range of transportation fees, insurance information, and the other.

Returning to FIG. 15, in step SC2, a person in charge in F corporation (see FIG. 1) operates the consignor client 100₁ input the pieces of information in the anonymous application information input column 801. In step SC3, the main control section 530 decides whether the search execution button 802 is depressed or not, and the main control section 530 decides the result as “No” to repeat the decision until the search execution button 802 is depressed. When the search execution button 802 is depressed by the person in charge, the main control section 530 determines the decision result in step SC3 as “Yes”.

In step SC4, the main control section 530 converts the address of the consignor input in step SC2 into a consignor municipal code and converts the address of the consignee into a consignee municipal code with reference to an address/municipal code conversion table (not shown). The main control section 530 searches the transportation fee information database 620 (see FIG. 5) by using, as keys, the consignor municipal code, the consignee municipal code, and the weight and the size input in step SC2. The searching result includes an assigned forwarding agent suitable for the transportation condition, a transportation fee, and the like.

As has been described above, when the transportation fee information database 620 includes a transportation service code for discriminating a plurality of transportation services from each other, the name or the like of a transportation service suitable for a searching condition can be obtained.

In step SC5, the main control section 530 searches the transportation assignment information database 660 (see FIG. 9) by using the consignor municipal code and the consignor municipal code (transportation interval) as keys. In step SC6, it is decided in the searching result in step SC5 whether the same transportation interval as the transportation interval related to the transportation request exists in the transportation assignment information database 660 or not. In this case, the result is decided as “No”.

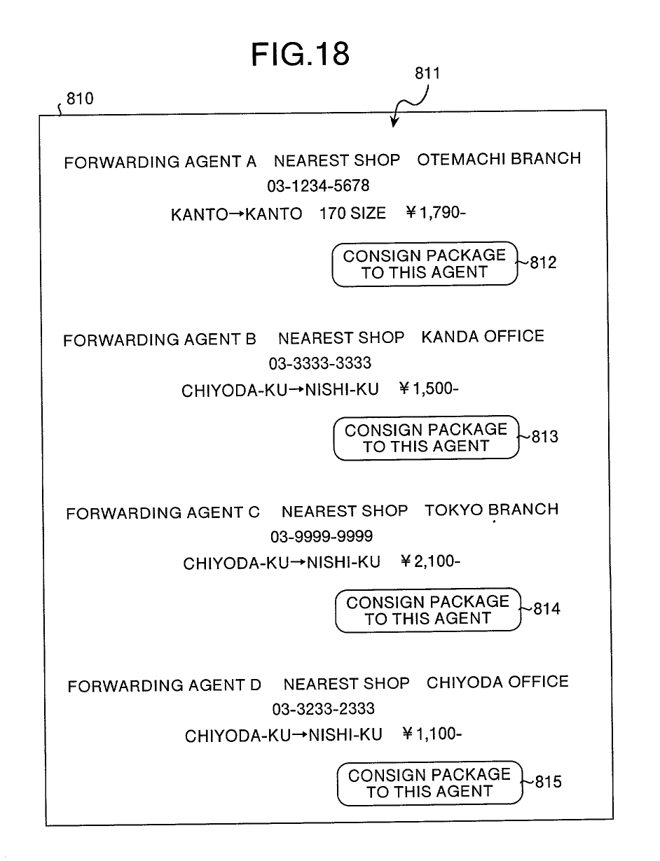

In step SC7, the main control section 530 the transportation assignee selection screen 810 shown in FIG. 18 on the display section of the consignor client 100₁ on the basis of the searching result of step SC4. In the transportation assignee selection screen 810, assignee information 811 constituted by a plurality of forwarding agents, transportation sections, sizes, and transportation fees which satisfy the transportation condition and assignment buttons 812 to 815 for selecting an assigned forwarding agent from the plurality of forwarding agents are displayed. In this embodiment, in the transportation assignee selection screen 810, information representing the types of the transportation services may be displayed together with the assignee information 811.

The transportation fee in the transportation assignee information 811 is a fixed transportation fee corresponding to the “transportation fee” of the transportation fee information database 620 (see FIG. 5). In the embodiment, a fixed transportation fee is not always displayed, and a discounted transportation fee (step SC8) (to be described later) may be displayed together with the fixed transportation fee.

Returning to FIG. 14, in step SB4, the main control section 530 decides whether one assignment button of the assignment buttons 812 to 815 shown in FIG. 18 is depressed or not. The main control section 530 decides the result as “No” to repeat the decision until the assignment button is depressed. A person in charge in F corporation selects a forwarding agent to which a transportation business of the package is assigned from the assignee information 811 by checking whether the forwarding agent is a custom or not or whether the forwarding agent is a forwarding agent having a minimum transportation fee as selection reference.

In this case, for example, the person in charge selects the forwarding agent A from the forwarding agent A to D, and depresses the assignment button 812 corresponding to the forwarding agent A. In this manner, the main control section 530 determines the decision result in step SB4 as “Yes”. In step SB5, the registration control section 550 registers information input to the anonymous application information input column 801 (see FIG. 17) in the transportation request information database 650 (see FIG. 8) as transportation request information.

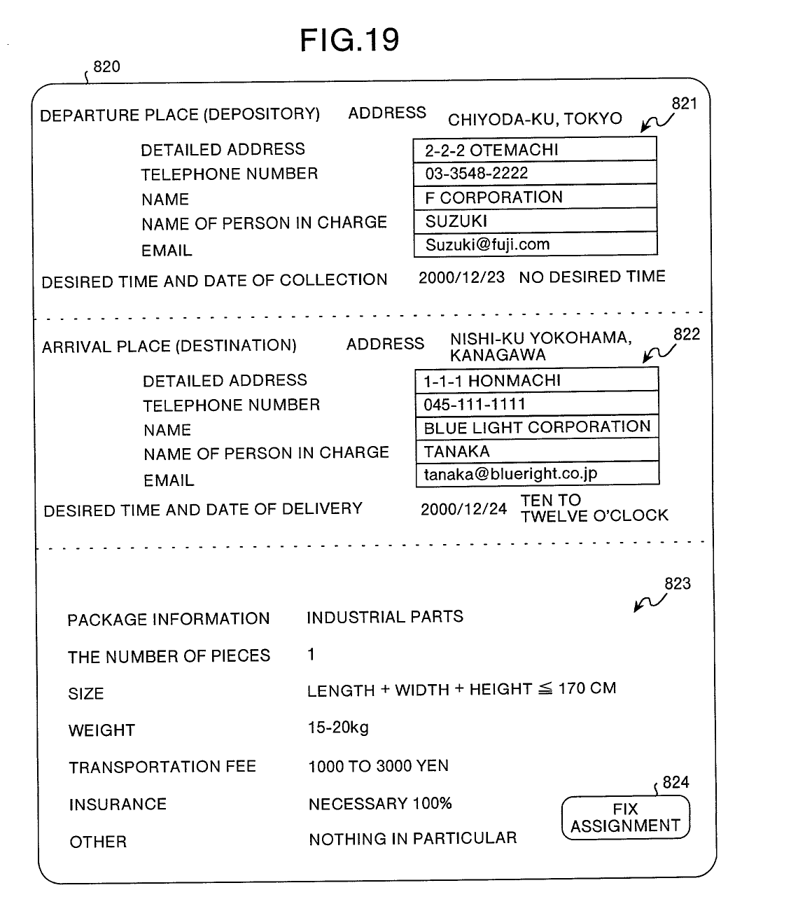

In step SB6, the main control section 530 displays a detailed information input screen 820 shown in FIG. 19 on the display section (not shown) of the consignor client 100₁. The detailed information input screen 820 is a screen used when a consignor input detailed information related to transportation with a real name. In the detailed information input screen 820, a consignor information input column 821, a consignee information input column 822, package information 823, and assignment fixing button 824 are displayed.

The consignor information input column 821 is a column for inputting a detailed address, a telephone number, a name, a person in charge, an E-mail address, and the like related to a consignor. The consignee information input column 822 is a column for inputting a detailed address, a telephone number, a name, a person in charge, and an E-mail address related to a consignee. The package information 823 is information related to a package input to the anonymous application information input column 801 (see FIG. 17). The assignment fixing button 824 is a button for fixing assignment of a transportation business to the forwarding agent.

In step SB7, a person in charge of a consignor (F corporation) operates the consignor client 100₁ to input detailed information in the consignor information input column 821 and the consignee information input column 822 (see FIG. 19). In step SB8, the main control section 530 decides whether the assignment fixing button 824 is depressed or not, and the main control section 530 decides the result as “No” to repeat the decision until the assignment fixing button 824 is depressed. When the assignment fixing button 824 is depressed, the main control section 530 determines the decision result in step sB8 as “Yes”.

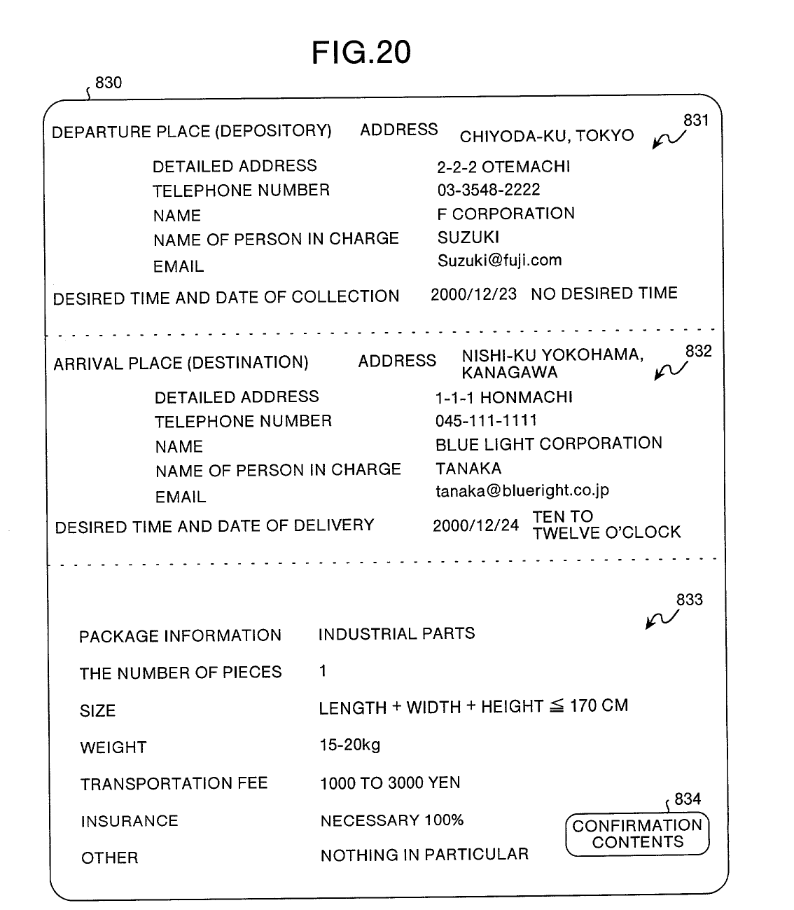

In step SB9, the main control section 530 displays a assignment contents confirmation screen 830 shown in FIG. 20 on the display section (not shown) of the consignor client 100₁. The assignment contents confirmation screen 830 is a screen for causing a person in charge to confirm the detailed information input in step SB7. In the assignment contents confirmation screen 830, consignor information 831, consignee information 832, package information 833, and a contents confirmation button 834.

The consignor information 831 and the consignee information 832 are pieces of detailed information which are input to the consignor information input column 821 and the consignee information input column 822 shown in FIG. 19, respectively. The package information 833 corresponds to the package information 823 (see FIG. 19). The contents confirmation button 834 is a button which is depressed when it is confirmed that information (assignment contents) in the assignment contents confirmation screen 830 is right.

In step SB10 shown in FIG. 14, the main control section 530 decides whether the contents confirmation button 834 is depressed or not, and the main control section 530 decides the result as “No” to repeat the decision until the contents confirmation button 834 is depressed. When the assignment fixing button 824 is depressed by the person in charge of the consignor, the main control section 530 determines the decision result in step SB10 as “Yes”.

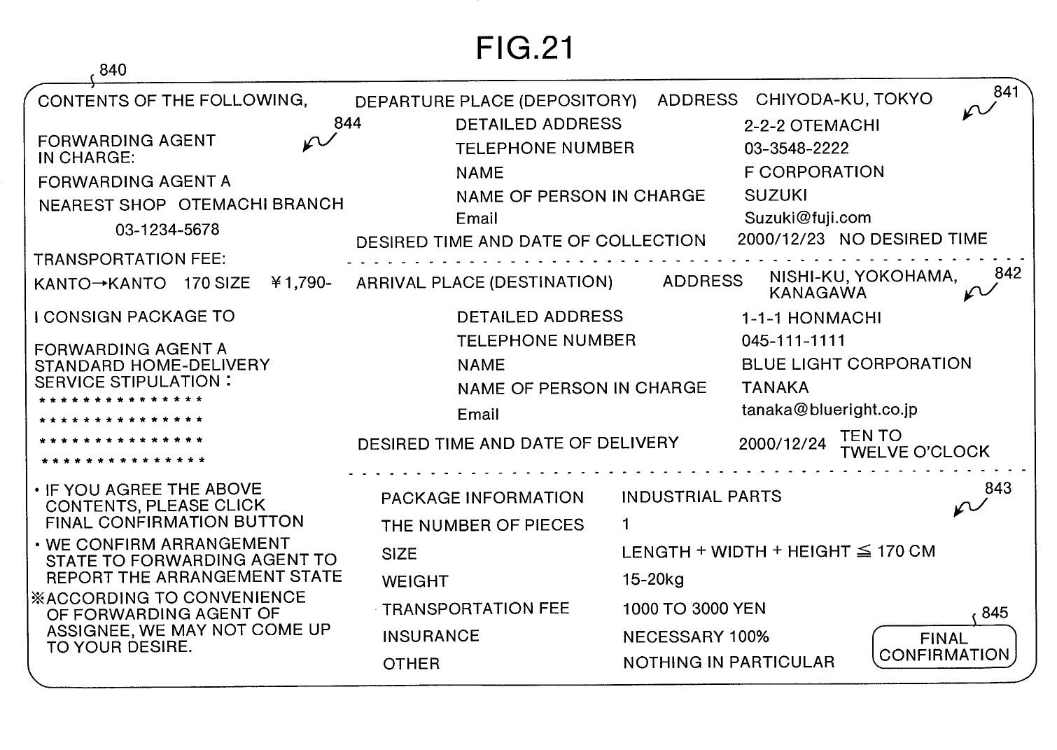

In step SB11, the main control section 530 displays a final confirmation screen 840 shown in FIG. 21 on the display section (not shown) of the consignor client 100₁. The final confirmation screen 840 is a screen for causing the person in charge of the consignor to finally confirm the assignment contents related to a transportation business.

On the final confirmation screen 840, consignor information 841, consignee information 842, package information 843, transportation information 844, and a final confirmation button 845 are displayed. The consignor information 841, the consignee information 842, and package information 843 correspond to the consignor information 831, the consignee information 832, and the package information 833 (see FIG. 20), respectively.

The transportation information 844 is information related to an assigned forwarding agent, a branch, a telephone number, a transportation interval, a transportation fee, and a provision. The final confirmation button 845 is a button depressed when it is confirmed that the information (assignment contents) on the final confirmation screen 840 is right.

In step SB12, the main control section 530 decides whether the final confirmation button 845 is depressed or not, and the main control section 530 decides the result as “No” to repeat the decision until the final confirmation button 845 is depressed. When the final confirmation button 845 is depressed by the person in charge of the consignor, the main control section 530 determines the decision result in step SB12 as “Yes”.

In step SB13, the registration control section 550 registers transportation assignment information in the transportation assignment information database 660 (see FIG. 9) on the basis of the information on the final confirmation screen 840. The registration control section 550 registers information related to the consignor and the consignee in the client information database 640 (see FIG. 7) as client information. In step SB14, the main control section 530 executes an ordering process of acquiring the transportation assignment information from the transportation assignment information database 660 and transmitting the transportation assignment information to the forwarding agent client 300₁ corresponding to assigned the forwarding agent A through the internet 200.

In step SB15, the main control section 530 decides whether an assignee notice is received from assigned the forwarding agent A, and the main control section 530 decides the result as “No” to repeat the decision until the notice is received. The transportation assignment information is received by the forwarding agent client 300₁, a person in charge in the forwarding agent A confirms the transportation assignment information and accept assignment of the transportation business.

In this manner, the forwarding agent A arranges a transportation vehicle or the like for transporting packages, instructs a departure branch which covers a transportation area corresponding to the consignor to collect the packages, and instructs an arrival branch which covers a transportation area corresponding to the consignee to deliver the packages to the consignee. The person in charge in the forwarding agent A operates forwarding agent client 300₁ to transmit transportation achievement information corresponding to the transportation achievement information master 671 (see FIG. 11) and the assignee notice information to the transportation intermediation apparatus 500.

When the transportation achievement information and the assignee notice information are received, the main control section 530 determines the decision result in step SB15 as “Yes”. In step SB16, the registration control section 550 registers the received transportation achievement information in the transportation achievement information master 671 (see FIG. 11).

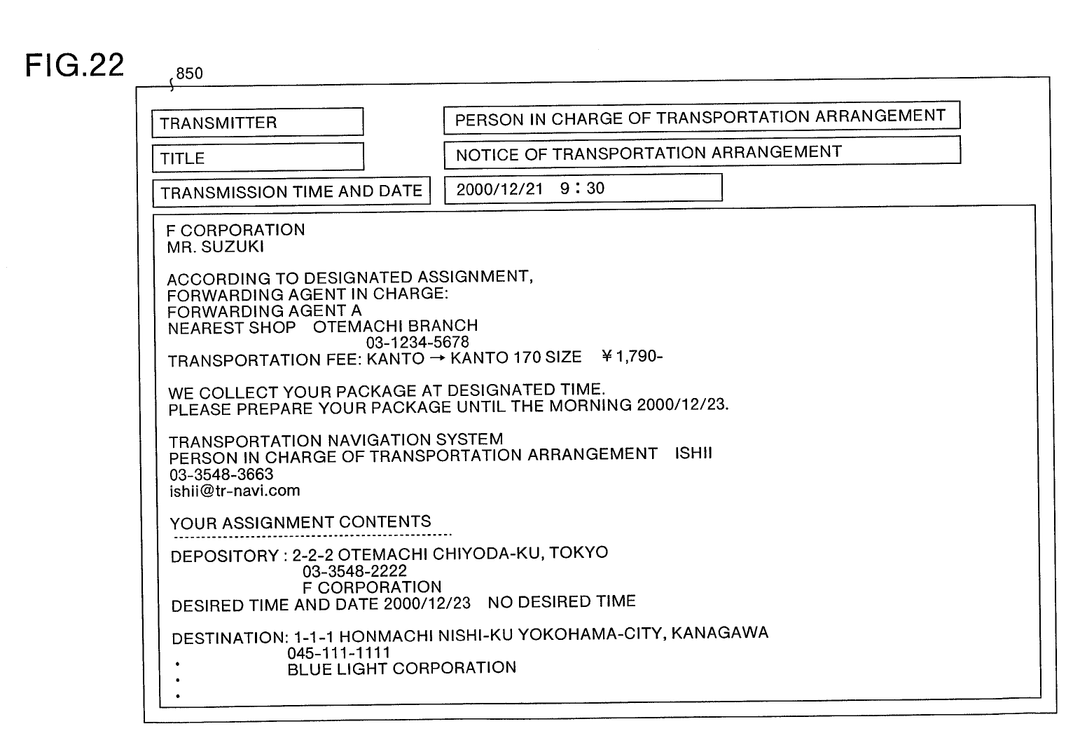

In step SB17, the mail control section 540 forms a order confirmation mail 850 shown in FIG. 22 on the basis of transportation assignment information. In the order confirmation mail 850, pieces of information such as an assigned forwarding agent, a transportation fee, time and date of collection, a person in charge of transportation intermediation service, and assignment contents are described.

The mail control section 540 transmits the order confirmation mail 850 to a person in charge of a consignor (F corporation) through the internet 200. When the order confirmation mail 850 is received by the consignor client 100₁, the person in charge of the consignor recognizes that the transportation procedure is completed.

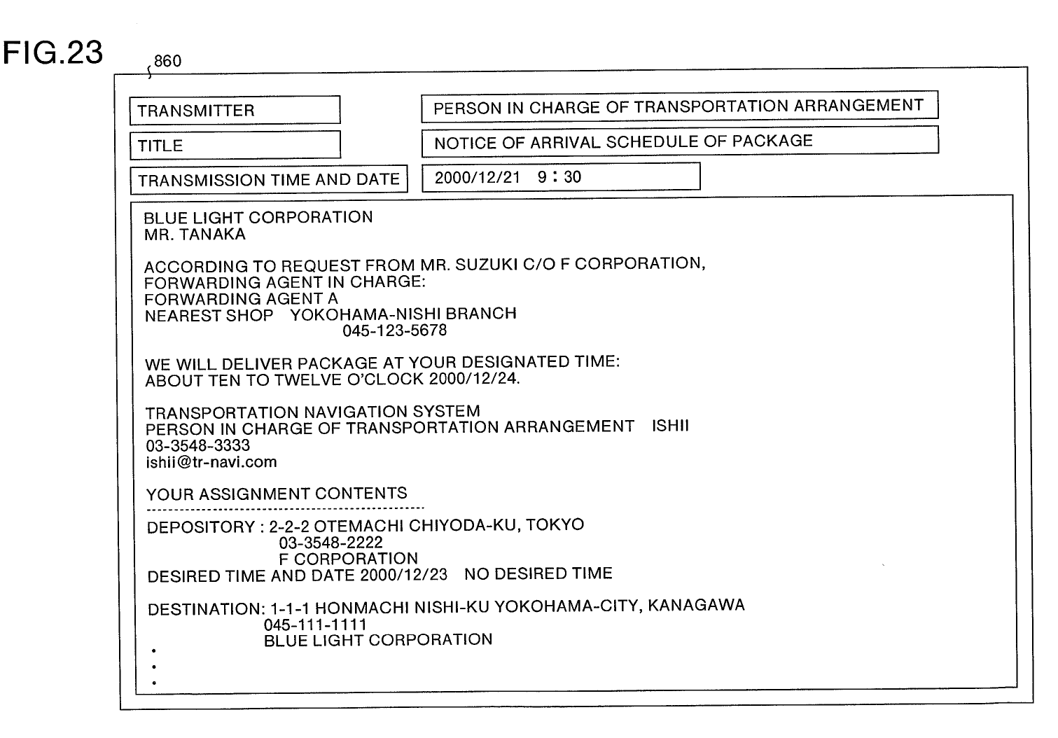

In step SB18, the mail control section 540 forms a reception request mail 860 shown in FIG. 23 on the basis of the transportation assignment information. In the reception request mail 860, pieces of information such as a consignor, time and date of delivery, a person in charge of transportation intermediation service, and the assignment contents of the consignor are described.

The mail control section 540 transmits the reception request mail 860 to the person in charge of the consignee (Blue Light corporation) through the internet 200. When the reception request mail 860 is received by the consignee client 400₁, the person in charge of the consignee recognizes that a package is delivered from F corporation (consignor).

In step SB19, the main control section 530 decides whether transportation status information from the forwarding agent client 300₁ is received or not, and the main control section 530 decides the result as “No” to repeat the decision until the transportation status information is received. In the embodiment, the mail control section 540 may transmit an inquiry mail for inquiring a transportation state from the forwarding agent client 300₁, and may decide whether a reply mail to the inquiry mail is received or not.

In step SB21, the main control section 530 decides whether transportation completion information from the forwarding agent client 300₁ is received or not, and the main control section 530 decides the result as “No” to perform the decision in step SB19 until the transportation completion information is received.

In transportation of a package from a consignor (F corporation) to a consignee (Blue Light corporation), when the package is delivered one hour behind schedule because of a traffic jam, the forwarding agent client 3001 transmits transportation status information (one hour behind schedule) to the transportation intermediation apparatus 500. When the transportation status information is received, the main control section 530 updates the “transportation status” of the transportation achievement information master 671 from “normal” to “abnormal” and updates the “transportation status consideration” from “nothing” to “one hour behind schedule because of traffic jam”, and the main control section 530 determines the decision result in step SB19 as “Yes”.

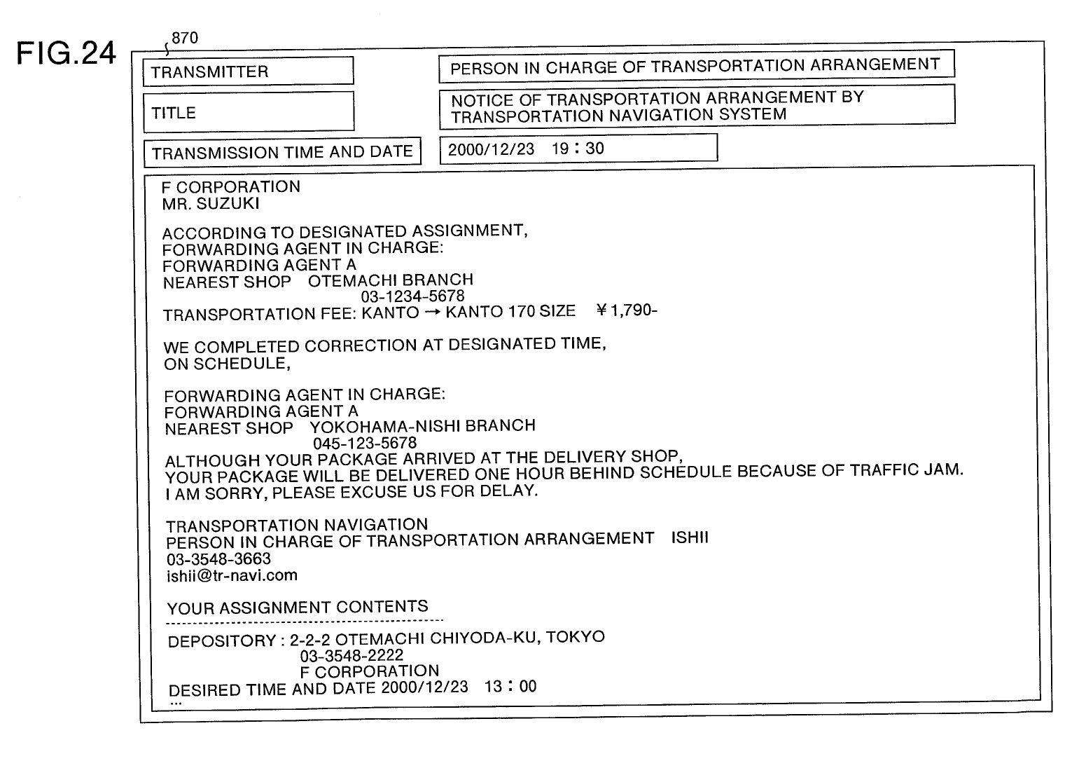

In step SB20, the mail control section 540 forms an in-progress mail 870 shown in FIG. 24 on the basis of the transportation status information. In the in-progress mail 870, information or the like related to a forwarding agent, a reason for delayed delivery, a delay of delivery, a person in charge of transportation intermediation service, and transportation assignment contents.

The mail control section 540 transmit the in-progress mail 870 to a consignor (F corporation) through the internet 200. When the in-progress mail 870 is received by the consignor client 100₁, a person in charge of the consignor recognizes that the delivery of the package is delayed.

When the package is delivered to the consignee (Blue Light corporation), transportation completion information is transmitted from the forwarding agent client 300₁ to the transportation intermediation apparatus 500. When the transportation intermediation apparatus 500 receives the transportation completion information, the main control section 530 determines the decision result in step SB21 as “Yes”.

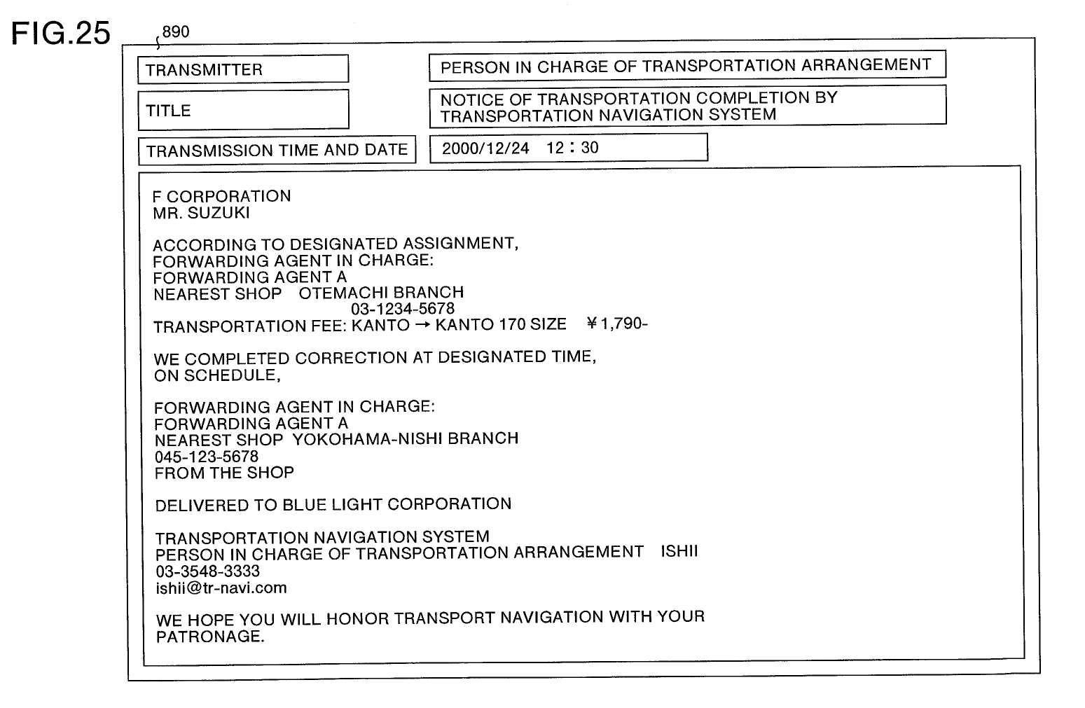

In step SB22, the mail control section 540 forms a transportation completion mail 890 shown in FIG. 25. In the transportation completion mail 890, information related to a forwarding agent, a report that delivery to the consignor is completed, a person in charge of transportation intermediation service, thanks for using the transportation intermediation service is described. The mail control section 540 transmits the transportation completion mail 890 to the consignor (F corporation) through the internet 200. When the transportation completion mail 890 is received by the consignor client 100₁, a person in charge of the consignor (F corporation) recognizes that the package is delivered to the consignee (Blue Light corporation) without any problem.

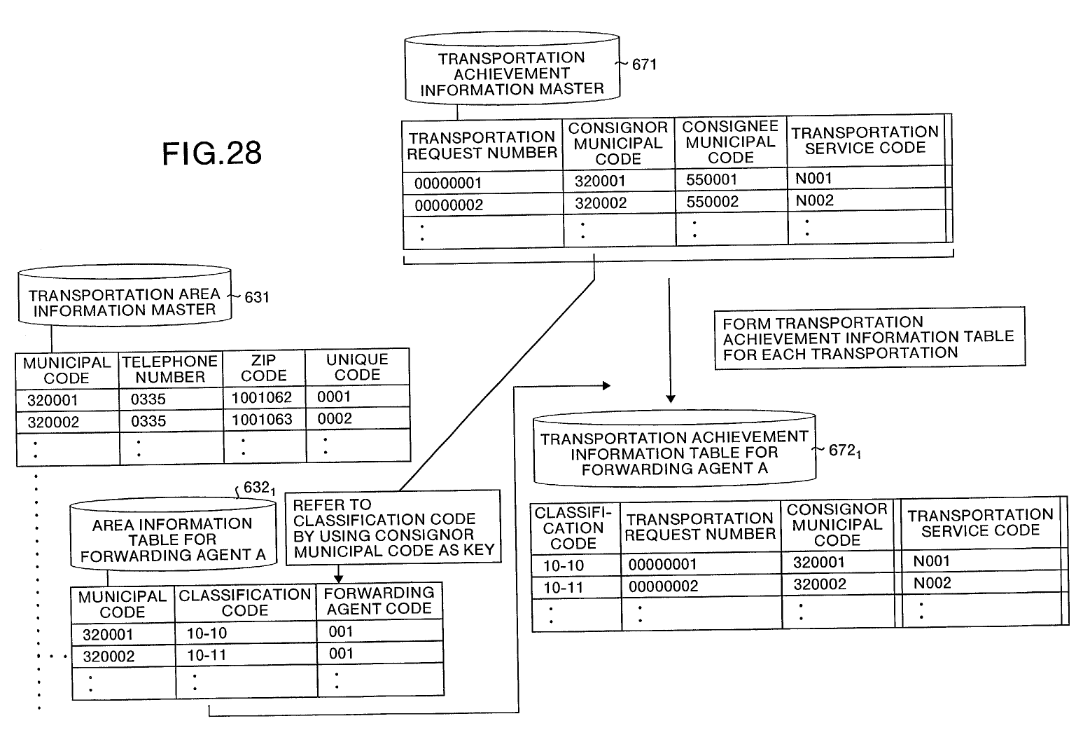

In step SB23, the main control section 530 forms a transportation achievement information table 672₁ for A corporation (see FIG. 12) and registers the transportation achievement information table 672₁ in the transportation achievement information database 670 (see FIG. 10). More specifically, the main control section 530 searches for a corresponding record from the transportation achievement information master 671 shown in FIG. 28 by using the transportation request number corresponding to the transportation request as a key.

The main control section 530 searches for a corresponding one of the plurality of area information table 632₁, . . . , for the forwarding agent A by using the “forwarding agent code” (see FIGS. 9 and 11) in the record of the searching result. In this case, the searching result is the area information table 632₁ for the forwarding agent A.

The main control section 530 refers to “classification code” of the area information table 632₁ for the forwarding agent A by using the “consignor municipal code” of the transportation achievement information master 671 as a key. Transportation achievement information related to the forwarding agent A in the transportation achievement information master 671 is set as the transportation achievement information for the forwarding agent A, and the “classification code” is added to the transportation achievement information for the forwarding agent A to form the transportation achievement information table 672₁ for the forwarding agent A (see FIG. 12). The transportation achievement information table 672₁ is registered in the transportation achievement information database 670 (see FIG. 10).

In step SB23, for example, by using a forwarding agent code (not shown) as a key, information for each forwarding agent may be extracted from the transportation achievement information master 671 as a batch process, and the information may be added to the classification code.

When transportation achievement information is requested from the forwarding agent client 300₁ (step SA18: see FIG. 13), the main control section 530 acquires the transportation achievement information for the forwarding agent A from the transportation achievement information table 672₁ and transmits the transportation achievement information to the forwarding agent client 300₁ through the internet 200 (step SA19: see FIG. 13). When the transportation achievement information for the forwarding agent A is received, the forwarding agent client 300₁ registers the transportation achievement information for the forwarding agent A in the database of a transportation management system (not shown) or updates the transportation achievement information.

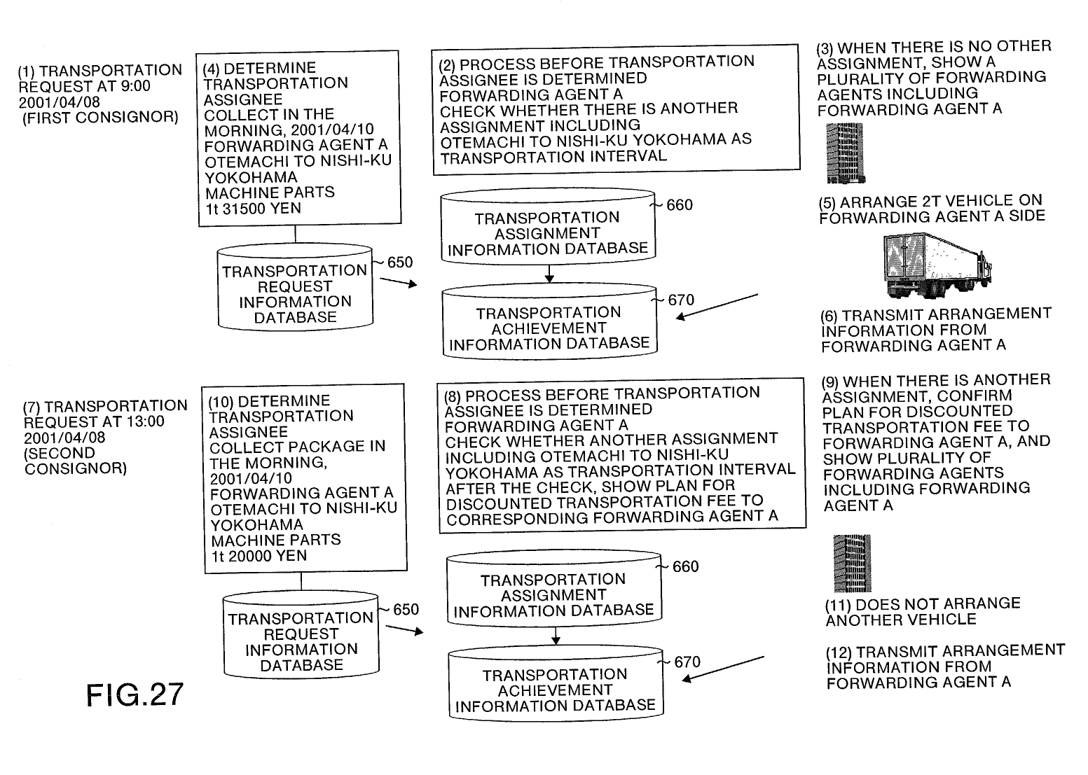

A case in which the decision result in step SC6 shown in FIG. 15 is “Yes”, i.e., a case in which the same transportation interval as the transportation interval related to a transportation request exists in the transportation assignment information database 660 (see FIG. 9) in the searching result in step SC5 will be described below with reference to FIG. 27.

FIG. 27 is a diagram for explaining a transportation fee discount process according to the embodiment. In FIG. 27, the following case will be described below. That is, when a first consignor and a second consignor coincidentally make transportation requests such that packages in the same transportation interval are collected in the same time zone, a transportation fee to be paid by the second consignor is discounted with respect to a transportation fee to be paid by the first consignor.

In (1) shown in FIG. 27, the first consignor accesses the transportation intermediation apparatus 500 at 9:00 on 2001/04/08, performs the above operation, and depresses a search execution button in step SC3 shown in FIG. 15. The main contents of the transportation request of the first consignor will be described below.

(Transportation Request Contents of First Consignor)

Time and date of collecting package: in the afternoon on 2001/04/10

Transportation interval: Otemachi to Nishi-ku Yokohama-city

Package information: Machine parts

Weight: 1 t

In (2), as a pre-process performed before a transportation assignee is determined, it is checked whether another assignment having the interval from Otemachi to Nishi-ku Yokohama-city as a transportation interval exists or not. More specifically, the main control section 530 executes the process in step SC5 (see FIG. 15), and the decision in step SC6 is performed. In this case, the main control section 530 determines the decision result in step SC6 as “No” and executes the processes subsequent to the process in step SC7.

In this manner, in (3) shown in FIG. 27, a plurality of forwarding agents including the forwarding agent A are shown to the first consignor as candidates of transportation assignees. In (4), the forwarding agent A is determined as a transportation assignee by the first consignor. In this case, a transportation fee shown by the forwarding agent A is 31,500 yen.

In (5), the forwarding agent A arranges, e.g., one 2 t-vehicle in accordance with a package (1 t) of the first consignor. In the 2 t-vehicle, since only the package having a weight of it is loaded, a capacity of it remains. More specifically, the loadage of the 2 t-vehicle is 50%. In (6), the forwarding agent A transmits arrangement information serving as a part of the transportation achievement information to the transportation intermediation apparatus 500.

In (7), the second consignor accesses the transportation intermediation apparatus 500 at 13:00 on 2001/04/08, performs the above operation, and depresses a search execution button in step SC3 shown in FIG. 15. The main contents of the transportation request of the second consignor will be described below.

(Transportation Request Contents of Second Consignor)

Time and date of collecting package: in the afternoon on 2001/04/10

Transportation interval: Otemachi to Nishi-ku Yokohama-city

Package information: Machine parts

Weight: 1 t

It is a notable point that the transportation interval and the time and date of collecting package in the transportation request contents of the second consignor are equal to the transportation interval and the time and date of collecting package in the transportation request contents of the first consignor. In (8), as a pre-process performed before a transportation assignee is determined, it is checked whether another assignment having the interval from Otemachi to Nishi-ku Yokohama-city as a transportation interval exists or not.

More specifically, the main control section 530 executes the process in step SC5 (see FIG. 15), and the decision in step SC6 is performed. In this case, the main control section 530 determines the decision result in step SC6 as “No” because the transportation interval (Otemachi to Nishi-ku Yokohama-city) according to the first consignor is equal to the transportation interval (Otemachi to Nishi-ku Yokohama-city) according to the second consignor and because the time and date of collecting the package according to the first consignor are equal to the time and date of collecting the package according to the second consignor.

In this case, in (9) shown in FIG. 27, the plan of the discounted transportation fee is confirmed by the forwarding agent A, and a plurality of forwarding agents including the forwarding agent A (discounted transportation fee) are shown as candidates of transportation assignees to the second consignor.

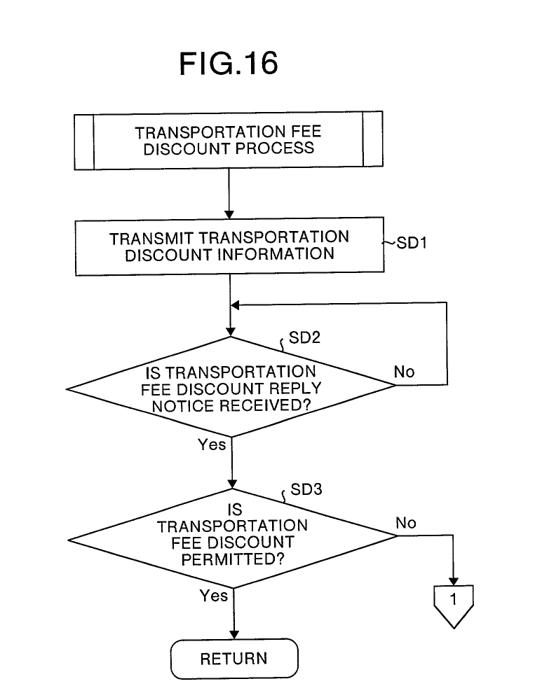

More specifically, in step SC8 shown in FIG. 15, the main control section 530 executes the transportation fee discount process. More specifically, in step SD1 shown in FIG. 16, the main control section 530 searches for the transportation achievement information master 671 by using, as a key, the transportation request number of the transportation assignment information including the same transportation interval and the same time and date of collection. The main control section 530 calculates a loadage on the basis of the carrying capacity of the arranged transportation vehicle and the weight of packages.

When there are pieces of transportation achievement information of the same transportation interval transportation sections, the same times and dates for collection, and the same transportation vehicles of packages to be transported, the weights of the packages are summed up to calculate a loadage. The main control section 530 generates transportation fee discount information with reference to the calculated loadage in the transportation interval and, e.g., the transportation fee discount percentage table which is set in advance.

(Transportation Fee Discount Percentage Table)

| Loadage | Transportation fee Discount Percentage |
|---|---|
| 80% to 100% | 0% |
| 50% to 79% | 36.5% |

When a package having a weight of 1 t is loaded on a 2 t-vehicle, the loadage is 50%. For this reason, the transportation fee discount percentage is 36.5%. Therefore, the discounted transportation fee is 20,000 yen (discounted transportation fee) which is obtained by multiplying, e.g., 31,500 yen (fixed transportation fee) by 63.5% (100% to 36.5%). The transportation fee discount percentage may be dependent on not only the loadage but also, e.g., the number of packages loaded on a transportation vehicle.

The main control section 530 transmits the discounted transportation fee information to the forwarding agent client 300₁ (the forwarding agent A) through the internet 200. In step SD2, the main control section 530 decides whether a transportation fee discount reply notice is received from the forwarding agent A or not, and the main control section 530 decides the result as “No” to repeat the decision until the transportation fee discount reply notice is received. The transportation fee discount reply notice is a notice representing whether the forwarding agent A permits the transportation fee discount or not. The transportation fee discount reply notice from the forwarding agent is made on real time.

When the transportation fee discount reply notice is received from the forwarding agent A through the internet 200, the main control section 530 determines the decision result in step SD2 as “Yes”. In step SD3, the main control section 530 decides whether transportation fee discount is permitted by the forwarding agent A or not. When the decision result is “No”, i.e., when the transportation fee discount is not permitted by the forwarding agent A, in step SC7 shown in FIG. 15, the main control section 530 displays the transportation assignee selection screen 810 in which the fixed transportation fee (31,500 yen) is set as the transportation fee of the forwarding agent A.

On the other hand, when the decision result in step SD3 shown in FIG. 16 is “Yes”, i.e., when a discounted transportation fee is permitted by the forwarding agent A, in step SC9 shown in FIG. 15, the main control section 530 displays a transportation assignee selection screen (not shown) in which the discounted transportation fee (20,000 yen) is set as the transportation fee of the forwarding agent A.

Although the plan of the discounted transportation fee is formed by the transportation intermediation apparatus 500, transportation fees are finally set depending on respective forwarding agents. Therefore, for example, in the embodiment, when the forwarding agent A notifies a consignee whether the discounted transportation fee is permitted or not, a discounted transportation fee obtained by correcting the plan of the discounted transportation fee formed by the transportation intermediation apparatus 500 may be sent as a reply.

In (10) shown in FIG. 27, the second consignor determines the forwarding agent A as a transportation assignee having the minimum transportation fee from the plurality of forwarding agents. In this case, the transportation fee shown by the forwarding agent A is 20,000 yen (discounted transportation fee).

In (11), the forwarding agent A does not arrange another vehicle because the package of the second consignor is loaded in the remaining space of the 2 t-vehicle which is arranged for the package (1 t) of the first consignor. More specifically, at this time, the loadage of the 2 t-vehicle is 100%. In (12), the forwarding agent A transmits the transportation status information (including the information of the loadage of 100%) to the transportation intermediation apparatus 500.

As described above, according to the embodiment, by using a transportation condition (see FIG. 17) input by the consignor as a key, a transportation fee of each forwarding agent is shown on the transportation assignee selection screen 810 (see FIG. 18) to the consignor, and the consignor orders a forwarding agent which is selected from the plurality of forwarding agents by the consignor to perform a transportation business. For this reason, the facilities for the consignor who receives the transportation service can be improved in comparison with a conventional case in which a consignor individually inquires of the plurality of forwarding agents, and a reduction in cost because transportation fees are compared with each other can be achieved.

According to the embodiment, as shown in FIG. 26, a classification code is converted into a municipal code or a unique code, and, as shown in FIG. 28, transportation achievement information of the package is managed by the transportation achievement information master 671 on the basis of the municipal code. The A transportation achievement information table 672₁ added with a classification code corresponding to the forwarding agent is notified to the forwarding agent in response to a request from the forwarding agent. For this reason, each forwarding agent can acquire the transportation achievement information without changing the business rule of the corresponding forwarding agent. Therefore, the facilities for the forwarding agent can be improved.

According to the embodiment, since slip forming information required for forming (step SA9 in FIG. 13) a slip related to transformation in a forwarding agent is notified to the forwarding agent (step SA5 in FIG. 13), a conventional operation for forming a slip on a consignor side can be omitted. For this reason, the facilities for the consignor can be more improved.

According to the embodiment, a discounted transportation fee depending on a loadage or the like of a transportation vehicle notified by a forwarding agent is shown to a consignor. For this reason, for example, when the loadage is low, i.e., when the carrying capacity of the transportation vehicle is not full, a transportation fee can be discounted, and the transportation service can be provided at a low cost. In addition, since the number of transportation assignments is expected to be increased by the discounted transportation fee, the transportation efficiency on the forwarding agent can be improved.

According to the embodiment, as described above with reference to FIG. 16, when a changed transportation fee is shown to a forwarding agent, and the change in transportation fee is permitted by the forwarding agent, the changed transportation fee is shown to a consignor. For this reason, a flexible transportation fee system can be realized, and the quality of service to clients can be improved.

According to the embodiment, since a consignee of a package is requested to receive the package, the facilities for the consignee can be improved, and it is expected that a possibility that the consignee is at home increases. For this reason, a redelivery rate decreases, and the transportation efficiency of the forwarding agent can be improved.

Although the embodiment of the present invention has been described above with reference to the accompanying drawings, a concrete configuration is not limited to the embodiment, and a change or the like of design without departing from the spirit and scope of the present invention is included in the present invention.

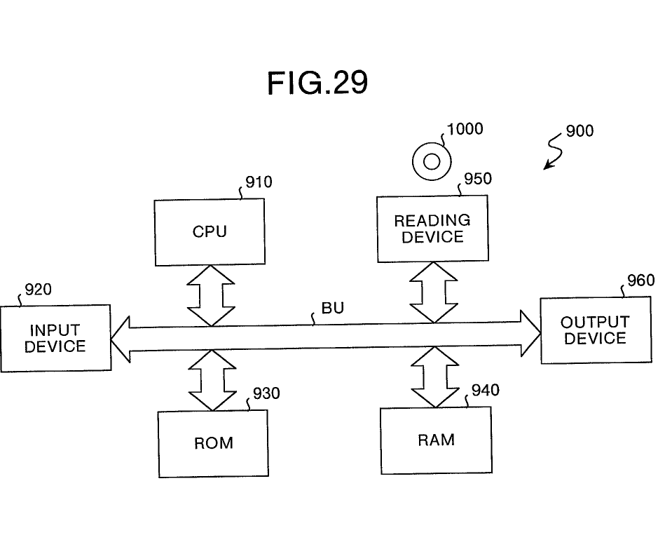

For example, in the embodiment described above, a transportation intermediation program for realizing the function of the transportation intermediation apparatus 500 is recorded on a computer readable recording medium 1000. The transportation intermediation program recorded on the recording medium 1000 is loaded on a computer 900 shown in FIG. 29 and executed, so that a series of processes related to transportation intermediation may be executed.

The computer 900 shown in FIG. 29, the computer 900 is constituted by a CPU 910 for executing the transportation intermediation program, an input device 920 such as a keyboard or a mouse, a ROM (Read Only Memory) 930 for storing various data, a RAM (Random Access Memory) 940 for storing a calculation parameter or the like, a reading device 950 for reading the transportation intermediation program from the recording medium 1000, an output device 960 such as a display or a printer, and a bus BU for connecting the respective components to each other.

The CPU 910 loads the transportation intermediation program recorded on the recording medium 1000 through the reading device 950 and executes the transportation intermediation program, so that the series of processes the transportation intermediation are executed. The recording medium 1000 includes not only a portable recording medium such as an optical disk, a floppy disk, or a hard disk, but also a transmission medium such as a network for temporarily recording or holding data.

As has been described above, according to one aspect of the present invention, by using a transportation condition input by a consignor as a key, transportation fees of respective forwarding agents are shown to the consignor, and a forwarding agent selected from the plurality of forwarding agents by the consignor is ordered to perform a transportation business. For this reason, the facilities for the consignor who receives the transportation service can be improved in comparison with a conventional case in which a consignor individually inquires of the plurality of forwarding agents, and a reduction in cost because transportation fees are compared with each other can be advantageously achieved.

According to another aspect of the present invention, unique transportation area information is converted into common transportation area information, transportation achievement information of a package is managed on the basis of the common transportation area information, and transportation achievement information added with the unique transportation area information corresponding to the forwarding agent is notified to the forwarding agent in accordance with a request form the forwarding agent. For this reason, each forwarding agent can acquire transportation achievement information without changing the business rule of the corresponding forwarding agent. Therefore, the facilities for the forwarding agent can be advantageously improved.

According to still another aspect of the present invention, a transportation fee depending on a loadage of a transportation vehicle notified by a forwarding agent is shown to a consignor. For this reason, for example, when the loadage is low, i.e., the carrying capacity of the transportation vehicle is not full, transportation fee can bed is counted, and the transportation service can be provided at a low cost. In addition, since the number of transportation assignments is expected to be increased by the discounted transportation fee, the transportation efficiency on the forwarding agent can be advantageously improved.

According to still another aspect of the present invention, a changed transportation fee is shown to the forwarding agent, and when change permission information is received from the forwarding agent, the changed transportation fee is shown to the consignor. For this reason, a flexible transportation fee system can be realized, and the quality of service to clients can be advantageously improved.

According to still another aspect of the present invention, since a reception request of a package is notified to a consignee of the package, the facilities for the consignee can be improved, and it is expected that a possibility that the consignee is at home increases. For this reason, a redelivery rate decreases, and the transportation efficiency of the forwarding agent can be advantageously improved.

What is claimed is:

1. A transportation intermediation method comprising the steps of:
causing a consignor to input transportation condition/s of a package;
searching a transportation information database based on the input transportation condition as key/s, wherein said transportation information database storing information regarding transportation fees corresponding to a plurality of forwarding agents;
providing information about transportation fee/s hit in the searching step and forwarding agent/s corresponding to hit transportation fee/s to the consignor;
making the consignor select a forwarding agent as a transportation assignee based on the information provided in the providing step; and
making an order to the forwarding agent selected by the consignor to perform transportation of the package.

2. The transportation intermediation method according to claim 1 further comprising the steps of:
converting unique transportation area information for discriminating transportation areas uniquely set by each forwarding agent into common transportation area information, which can be commonly used by all of the forwarding agents, for discriminating the transportation areas from each other;
managing transportation achievement information of the package on the basis of the common transportation area information; and
notifying the forwarding agent of transportation achievement information added with the unique transportation area information corresponding to the forwarding agent in accordance with a request from the forwarding agent.

3. The transportation intermediation method according to claim 1, wherein when making an order to the forwarding agent, slip forming information required for creating a slip related to transportation by the forwarding agent is notified to the forwarding agent.

4. The transportation intermediation method according to claim 1, further comprising the step of managing a loadage of a transportation vehicle notified by the forwarding agent,
wherein when providing information about transportation fee/s to the consignor, transportation fee/s calculated based on the loadage is/are provided to the consignor.

5. The transportation intermediation method according to claim 4, wherein when providing information about transportation fee/s to the consignor, it is checked whether the loadage is not higher than a predetermined percentage, and if the loadage is not higher than the predetermined percentage then discounted transportation fee/s is/are provided to the consignor.

6. The transportation intermediation method according to claim 4, further comprising the steps of:
providing the transportation fee calculated based on the loadage to the forwarding agent; and
receiving a post on willingness or non-willingness of acceptance of the transportation business from the forwarding agent,
wherein when information about transportation fee/s is provided to the consignor only when a post on willingness of acceptance of the transportation business is received from the forwarding agent.

7. The transportation intermediation method according to claim 1, further comprising the step of notifying a request for reception of the package to the consignee of the package.

8. A transportation intermediation apparatus comprising:
an input unit through which a consignor inputs transportation condition/s of a package;
a searching unit which searches a transportation information database based on the input transportation condition/s as key/s, wherein said transportation information database storing information regarding transportation fees corresponding to a plurality of forwarding agents;
an information providing unit which provides information about transportation fee/s hit in the search by said searching unit and forwarding agent/s corresponding to hit transportation fee/s to the consignor;
a selection unit through which the consignor selects one forwarding agent as a transportation assignee based on the information provided by said information providing unit; and
an order making unit which makes an order to the forwarding agent selected by the consignor to perform transportation of the package.

9. A computer program containing instructions which when executed on a computer causes the computer to perform the steps of:
causing a consignor to input transportation condition/s of a package;
searching a transportation information database based on the input transportation condition as key/s, wherein said transportation information database storing information regarding transportation fees corresponding to a plurality of forwarding agents;
providing information about transportation fee/s hit in the searching step and forwarding agent/s corresponding to hit transportation fee/s to the consignor;
making the consignor select a forwarding agent as a transportation assignee based on the information provided in the providing step; and
making an order to the forwarding agent selected by the consignor to perform transportation of the package.
